(19) United States
(12) Patent Application Publication
(10) Pub. No.: US 2026/0206798 A1
(43) Pub. Date: Jul. 23, 2026

(54) PACKAGED BEVERAGE

(71) Applicant: SUNTORY HOLDINGS LIMITED, Osaka-shi, Osaka (JP)

(72) Inventors: Yasuhiro Sueyoshi, Mishima-gun, Osaka (JP); Koichi Nakahara, Soraku-gun, Kyoto (JP)

(73) Assignee: SUNTORY HOLDINGS LIMITED, Osaka-shi, Osaka (JP)

(21) Appl. No.: 19/140,514

(22) PCT Filed: Dec. 22, 2023
(86) PCT No.: PCT/JP2023/046071

§ 371 Date: Jun. 18, 2025

(30) Foreign Application Priority Data
Dec. 23, 2022 (JP) 2022-207129

(51) Int. Cl. A23L 2/52; A23L 2/38; A23L 7/25; A23L 27/24; B65D 1/02; B65D 85/72

(52) U.S. Cl. CPC A23L 2/52; A23L 2/382; A23L 7/25; A23L 27/24; B65D 1/0215; B65D 85/72

(57) ABSTRACT

A packaged beverage is provided. The beverage is filled in a container in which a redox potential is adjusted to 5.00 mV or less by using a hydrogen generating material. Provided also is a packaged grain beverage having an oxidation-reduction potential of 5.00 mV or less. Provided also is a packaged beer-taste beverage having an oxidation-reduction potential of 5.00 mV or less.

### TECHNICAL FIELD

The present invention relates to a packaged beverage, a method for producing a packaged beverage, a method for suppressing deterioration of a packaged beverage, and a beverage filling container.

### BACKGROUND ART

A large number of packaged beverages obtained by filling various beverages into containers are distributed in the market regardless of Japan and foreign countries. However, the packaged beverages involve a problem that flavors of the beverages immediately after being filled into the containers decrease with time. Therefore, there is a demand for a technique for suppressing a decrease in flavor of a packaged beverage.

In response to such a problem, for example, Patent Document 1 describes that a packaged beverage containing a bitterness/astringency-suppressing composition containing 2,3-diethyl-5-methylpyrazine in a plant-derived raw material exhibiting bitterness/astringency can be suppressed in bitterness/astringency while retaining an original flavor of a plant material.

### CITATION LIST

### Patent Document

Patent Document 1: JP 2021-073949 A

### SUMMARY OF INVENTION

### Technical Problem

The bitterness/astringency-suppressing composition described in Patent Document 1 is mainly intended for tea beverages, and types of applicable beverages are limited. Under such circumstances, there is a demand for a packaged beverage that can be suppressed in decrease in flavor regardless of the type of beverage.

### Solution to Problem

The present invention provides a packaged beverage whose oxidation-reduction potential is adjusted to a prescribed value or less by using a hydrogen generating material. Specifically, the present invention provides the following embodiments [1] to [22].

[1]

A packaged beverage in which a beverage is filled in a container,
the packaged beverage having an oxidation-reduction potential adjusted to 5.00 mV or less with a hydrogen generating material.
   [2]

The packaged beverage according to [1], wherein the packaged beverage has a real extract concentration of 0.1 mass % or more.

[3]

The packaged beverage according to [1] or [2], wherein the beverage is drinking water, a carbonated beverage, a fruit beverage, a vegetable beverage, a fruit juice beverage, a vegetable juice beverage, a fruit juice-flavored beverage, a vegetable juice-flavored beverage, a fruit pulp beverage, a flavored beverage, a flavored syrup, an acidic beverage produced from milk or a dairy product, a coffee beverage, a caffeine beverage, a tea-based beverage, a soymilk beverage, or an alcoholic beverage.

[4]

The packaged beverage according to [1] or [2], wherein the beverage is a beer-taste beverage.

[5]

The packaged beverage according to any one of [1] to [4], wherein the container is a bottle, a can, a bottle can, a barrel, a PET bottle, a plastic bottle, or a stainless steel container.

[6]

The packaged beverage according to any one of [1] to [5], wherein the packaged beverage has a gas pressure of 0.01 kg/cm² or more.

[7]

The packaged beverage according to any one of [1] to [6], wherein an additive containing the hydrogen generating material is incorporated into the beverage or the container.

[8]

The packaged beverage according to any one of [1] to [7], wherein the container is a beverage filling container (I) having a layer containing the hydrogen generating material and/or a beverage filling container (II) in which a member containing the hydrogen generating material is present.

[9]

The packaged beverage according to any one of [1] to [8], wherein the hydrogen generating material contains one or more selected from a metal, a metal alloy, and a metal compound.

[10]

The packaged beverage according to any one of [1] to [8], wherein the hydrogen generating material contains one or more selected from magnesium hydride, calcium hydride, barium hydride, beryllium hydride, strontium hydride, lithium hydride, sodium hydride, sodium borohydride, lithium sodium hydride, silicon hydride, magnesium, and a magnesium alloy.

[11]

The packaged beverage according to any one of [1] to [10], wherein a content of an antioxidant is 1.0 mass % or less.

[12]

The packaged beverage according to any one of [1] to [11], wherein an amount of dissolved oxygen is 14 mg/L or less.

[13]

A packaged grain beverage having an oxidation-reduction potential of 5.00 mV or less.

[14]

A packaged beer-taste beverage having an oxidation-reduction potential of 5.00 mV or less.

[15]

A method for producing a packaged beverage, the method including a step (A) of adjusting an oxidation-reduction potential of a beverage to 5.00 mV or less with a hydrogen generating material.

[16]

The method for producing a packaged beverage according to [15], wherein, in the step (A), the oxidation-reduction potential of the beverage is adjusted to 5.00 mV or less with the hydrogen generating material after the beverage is filled in a container.

[17]

The method for producing a packaged beverage according to [15] or [16], wherein the step (A) is carried out by incorporating an additive containing the hydrogen generating material into the beverage or the container.

[18]

The method for producing a packaged beverage according to [15] or [16], wherein the step (A) is carried out by filling the beverage in a beverage filling container (I) having a layer containing the hydrogen generating material or in a beverage filling container (II) in which a member containing the hydrogen generating material is present.

[19]

The method for producing a packaged beverage according to any one of [15] to [18], wherein the hydrogen generating material contains one or more selected from a metal, a metal alloy, and a metal compound.

[20]

The method for producing a packaged beverage according to any one of [15] to [18], wherein the hydrogen generating material contains one or more selected from magnesium hydride, calcium hydride, barium hydride, beryllium hydride, strontium hydride, lithium hydride, sodium hydride, sodium borohydride, lithium sodium hydride, silicon hydride, magnesium, and a magnesium alloy.

[21]

A method for suppressing deterioration of a packaged beverage, the method including adjusting an oxidation-reduction potential of a beverage to 5.00 mV or less with a hydrogen generating material.

[22]

A beverage filling container having a layer containing a hydrogen generating material and/or a member containing a hydrogen generating material.

### Advantageous Effects of Invention

A packaged beverage according to a preferred embodiment of the present invention can be suppressed in decrease in flavor regardless of the type of beverage.

### DESCRIPTION OF EMBODIMENTS

### 1 Packaged Beverage

A packaged beverage according to an embodiment of the present invention is a packaged beverage in which a beverage is filled in a container, the packaged beverage having an oxidation-reduction potential adjusted to 5.00 mV or less using a hydrogen generating material.

In an embodiment of the present invention, the oxidation-reduction potential of the beverage before being filled into the container is not particularly limited, and the oxidation-reduction potential of the packaged beverage after being filled into the container needs to be 5.00 mV or less.

As used herein, the “packaged beverage” refers to a beverage after being filled into a container, and is distinguished from a beverage before being filled. The “packaged beverage” may be a beverage in a state after being further sealed, or may be a beverage in a state before being sealed.

In general, a packaged beverage involves a problem that a flavor of the beverage gradually deteriorates over time as compared with the flavor immediately after the beverage is filled in a container. Depending on the storage environment of the packaged beverage, deterioration of the flavor may be accelerated. In order to suppress the deterioration of the flavor of the packaged beverage, it is also conceivable to incorporate a preparation such as the bitterness/astringency-suppressing composition described in Patent Document 1. However, depending on the beverage, the addition of the preparation changes the flavor of the beverage, and thus types of applicable beverages are limited.

As a result of intensive studies to solve such a problem, the present inventors have found that a decrease in flavor of a packaged beverage can be suppressed, regardless of the type of beverage, by using a hydrogen generating material to generate hydrogen in the filled beverage and adjusting an oxidation-reduction potential of the beverage to 5.00 mV or less.

As a method of generating hydrogen in the beverage, a method of electrolyzing water in the beverage is also conceivable. However, there is a concern that, when an electrolysis treatment is performed on a beverage containing various aroma components, such as a beer-taste beverage, the amount of the aroma components decreases simultaneously with the generation of hydrogen, thereby causing a decrease in flavor. In addition, the electrolysis treatment also generates oxygen, which may cause oxidation of the beverage.

It is also conceivable to directly introduce hydrogen gas into the beverage to bring it into contact with the beverage. However, this method involves a concern that, when hydrogen gas is introduced, the aroma components contained in the beverage are removed, thereby causing a decrease in flavor.

On the other hand, when the hydrogen generating material is used as in the packaged beverage according to an embodiment of the present invention, hydrogen can be gradually brought into contact with the beverage, and a decrease in aroma components contained in the beverage can be suppressed. In addition, the oxidation-reduction potential of the packaged beverage can be lowered, and an effect of suppressing a decrease in flavor of the beverage over time can be enhanced.

The oxidation-reduction potential of the packaged beverage according to an embodiment of the present invention is preferably 5.00 mV or less, 4.00 mV or less, 3.00 mV or less, 2.00 mV or less, 1.00 mV or less, 0.50 mV or less, 0.25 mV or less, 0.20 mV or less, 0.10 mV or less, 0.05 mV or less, 0.02 mV or less, 0.01 mV or less, 0.00 mV or less, −0.01 mV or less, −0.05 mV or less, −0.10 mV or less, −0.30 mV or less, −0.50 mV or less, −0.70 mV or less, −1.00 mV or less, −1.50 mV or less, −2.00 mV or less, −2.50 mV or less, −3.00 mV or less, −3.50 mV or less, −4.00 mV or less, −4.50 mV or less, −5.00 mV or less, −5.50 mV or less, −6.00 mV or less, −6.50 mV or less, −7.00 mV or less, −8.00 mV or less, −9.00 mV or less, −10.0 mV or less, −15.0 mV or less, −20.0 mV or less, −25.0 mV or less, −30.0 mV or less, −35.0 mV or less, −40.0 mV or less, −45.0 mV or less, −50.0 mV or less, −55.0 mV or less, −60.0 mV or less, −65.0 mV or less, −70.0 mV or less, −75.0 mV or less, −80.0 mV or less, −85.0 mV or less, −90.0 mV or less, −95.0 mV or less, −100 mV or less, −105 mV or less, −110 mV or less, −115 mV or less, −120 mV or less, −125 mV or less, −130 mV or less, −135 mV or less, −140 mV or less, −145 mV or less, −150 mV or less, −155 mV or less, −160 mV or less, −165 mV or less, −170 mV or less, −175 mV or less, −180 mV or less, −185 mV or less, −190 mV or less, −195 mV or less, −200 mV or less, −205 mV or less, −210 mV or less, −215 mV or less, −220 mV or less, −225 mV or less, −230 mV or less, −235 mV or less, −240 mV or less, −250 mV or less, −260 mV or less, −270 mV or less, −280 mV or less, −290 mV or less, −300 mV or less, −310 mV or less, −320 mV or less, −330 mV or less, −340 mV or less, −350 mV or less, −360 mV or less, −370 mV or less, −380 mV or less, −390 mV or less, or −400 mV or less, and may be −1000 mV or more, −950 mV or more, −900 mV or more, −850 mV or more, −800 mV or more, −750 mV or more, −700 mV or more, −650 mV or more, −600 mV or more, −550 mV or more, −500 mV or more, −450 mV or more, −400 mV or more, −350 mV or more, or −300 mV or more.

In an embodiment of the present invention, the oxidation-reduction potential of the beverage before being filled into the container is not particularly limited, and may be in the same range as that of the above-packaged beverage after being filled into the container, may be more than 0.01 mV, or may be −1.00 mV or more, −0.70 mV or more, −0.50 mV or more, −0.30 mV or more, −0.10 mV or more, −0.05 mV or more, −0.01 mV or more, or −0.00 mV or more.

Herein, the oxidation-reduction potential is an oxidation-reduction potential of a beverage measured at 20° C. As a specific measurement method, the oxidation-reduction potential can be measured using a product under the name “ORP Meter HM-40P” (available from DKK-TOA CORPORATION) after a packaged beverage at 20° C. is opened and transferred to a beaker.

In the packaged beverage according to an embodiment of the present invention, as the hydrogen generating material used for adjusting the oxidation-reduction potential to the above-described range, any material can be used as long as it generates hydrogen when coming into contact with the beverage.

Among these, the hydrogen generating material used in an embodiment of the present invention preferably contains one or more selected from a metal, a metal alloy, and a metal compound from the viewpoint of suppressing the influence on the flavor of the packaged beverage, and more preferably contains one or more selected from magnesium hydride, calcium hydride, barium hydride, beryllium hydride, strontium hydride, lithium hydride, sodium hydride, sodium borohydride, sodium lithium hydride, silicon hydride, magnesium, and a magnesium alloy, even more preferably contains one or more selected from magnesium hydride, calcium hydride, and barium hydride, and still even more preferably contains at least magnesium hydride from the viewpoint of more efficiently lowering the oxidation-reduction potential.

In the packaged beverage according to an embodiment of the present invention, the content of the hydrogen generating material is appropriately adjusted so that the oxidation-reduction potential becomes a predetermined value, and may be, for example, 0.001 g/L or more, 0.002 g/L or more, 0.004 g/L or more, 0.006 g/L or more, 0.008 g/L or more, 0.010 g/L or more, 0.020 g/L or more, 0.040 g/L or more, 0.060 g/L or more, 0.080 g/L or more, 0.10 g/L or more, 0.12 g/L or more, 0.14 g/L or more, 0.16 g/L or more, 0.18 g/L or more, 0.20 g/L or more, 0.22 g/L or more, 0.24 g/L or more, 0.26 g/L or more, 0.28 g/L or more, 0.30 g/L or more, 0.32 g/L or more, 0.34 g/L or more, 0.36 g/L or more, 0.38 g/L or more, 0.40 g/L or more, 0.42 g/L or more, 0.44 g/L or more, 0.46 g/L or more, 0.48 g/L or more, 0.50 g/L or more, 0.52 g/L or more, 0.54 g/L or more, 0.56 g/L or more, 0.58 g/L or more, 0.60 g/L or more, 0.62 g/L or more, 0.64 g/L or more, 0.66 g/L or more, 0.68 g/L or more, 0.70 g/L or more, 0.72 g/L or more, 0.74 g/L or more, 0.76 g/L or more, 0.78 g/L or more, 0.80 g/L or more, 0.82 g/L or more, 0.84 g/L or more, 0.86 g/L or more, 0.88 g/L or more, 0.90 g/L or more, 0.92 g/L or more, 0.94 g/L or more, 0.96 g/L or more, 0.98 g/L or more, 1.00 g/L or more, 1.02 g/L or more, 1.04 g/L or more, 1.06 g/L or more, 1.08 g/L or more, 1.10 g/L or more, 1.12 g/L or more, 1.14 g/L or more, 1.16 g/L or more, 1.18 g/L or more, or 1.20 g/L or more, and may be 20.0 g/L or less, 18.0 g/L or less, 16.0 g/L or less, 15.0 g/L or less, 14.0 g/L or less, 13.0 g/L or less, 12.0 g/L or less, 11.0 g/L or less, 10.0 g/L or less, 9.5 g/L or less, 9.0 g/L or less, 8.5 g/L or less, 8.0 g/L or less, 7.5 g/L or less, 7.0 g/L or less, 6.5 g/L or less, 6.0 g/L or less, 5.5 g/L or less, 5.0 g/L or less, 4.5 g/L or less, 4.0 g/L or less, 3.5 g/L or less, 3.0 g/L or less, 2.5 g/L or less, 2.0 g/L or less, 1.9 g/L or less, 1.8 g/L or less, 1.7 g/L or less, 1.6 g/L or less, 1.5 g/L or less, 1.4 g/L or less, 1.3 g/L or less, 1.2 g/L or less, 1.1 g/L or less, 1.0 g/L or less, 0.95 g/L or less, 0.90 g/L or less, 0.85 g/L or less, 0.80 g/L or less, 0.75 g/L or less, 0.70 g/L or less, 0.65 g/L or less, 0.60 g/L or less, 0.55 g/L or less, or 0.50 g/L or less.

The packaged beverage according to an embodiment of the present invention may be a packaged beverage in which an additive containing the hydrogen generating material is incorporated into the beverage or the container.

That is, the packaged beverage according to an embodiment of the present invention may be prepared by adding the additive to the beverage previously filled in the container, or may be prepared by charging the additive into the container and then filling the beverage therein.

The additive containing the hydrogen generating material may be an additive composed only of the hydrogen generating material, may be a mixture of the hydrogen generating material and a food additive as determined to be usable by an Minister of Health, Labour and Welfare based on Article 12 of the Food Sanitation Act, or may be a mixture of the hydrogen generating material and various foods such as starches. The additive containing the hydrogen generating material may be an additive which is harmless to the human body but is not edible, and examples thereof include a mixture of the hydrogen generating material and a resin component.

The content proportion of the hydrogen generating material in the additive used in an embodiment of the present invention may be 0.0001 mass % or more, 0.001 mass % or more, 0.01 mass % or more, 0.1 mass % or more, 1.0 mass % or more, 5.0 mass % or more, 10 mass % or more, 20 mass % or more, 30 mass % or more, 40 mass % or more, 50 mass % or more, 60 mass % or more, 70 mass % or more, 80 mass % or more, 90 mass % or more, or 95 mass % or more, or may be 100 mass % or less, 95 mass % or less, 90 mass % or less, 80 mass % or less, 70 mass % or less, 60 mass % or less, 50 mass % or less, 40 mass % or less, 30 mass % or less, 20 mass % or less, or 10 mass % or less based on the total amount (100 mass %) of the additive.

In the packaged beverage according to an embodiment of the present invention, examples of the container to be filled with the beverage include a bottle, a can, a bottle can, a barrel, a PET bottle, a plastic bottle, and a stainless steel container.

Examples of the “can” include a can which can be opened from a closed state by a pull tab or a stay-on tab, and may be a steel can or an aluminum can.

Examples of the “bottle can” include a can which can be opened or closed by a screw-type lid on an upper portion of a predetermined container, and may be a steel can or an aluminum can. Note that the “bottle can” is different from the “can” in that it can be brought into a closed state again even if it is once opened.

In the packaged beverage according to an embodiment of the present invention, the volume of the container to be filled with the beverage may be, for example, 50 mL or more, 100 mL or more, 150 mL or more, 200 mL or more, 250 mL or more, 300 mL or more, 350 mL or more, 400 mL or more, 450 mL or more, 500 mL or more, 550 mL or more, 600 mL or more, 650 mL or more, 700 mL or more, 750 mL or more, 800 mL or more, 850 mL or more, 900 mL or more, 950 mL or more, 1000 mL or more, 1100 mL or more, 1200 mL or more, 1300 mL or more, 1400 mL or more, 1500 mL or more, 1600 mL or more, 1700 mL or more, 1800 mL or more, 1900 mL or more, 2000 mL or more, 3000 mL or more, 4000 mL or more, 5000 mL or more, 6000 mL or more, 7000 mL or more, 8000 mL or more, 9000 mL or more, 10 L or more, 20 L or more, 30 L or more, 40 L or more, 50 L or more, 60 L or more, 70 L or more, 80 L or more, 90 L or more, or 100 L or more, and may be 1000 L or less, 900 L or less, 800 L or less, 700 L or less, 600 L or less, 500 L or less, 400 L or less, 300 L or less, 200 L or less, 100 L or less, 90 L or less, 80 L or less, 70 L or less, 60 L or less, 50 L or less, 40 L or less, 30 L or less, 20 L or less, 10 L or less, 9500 mL or less, 8500 mL or less, 7500 mL or less, 6500 mL or less, 5500 mL or less, 4500 mL or less, 3500 mL or less, 2500 mL or less, 1500 mL or less, 1000 mL or less, 750 mL or less, or 500 mL or less.

The packaged beverage according to an embodiment of the present invention may be a packaged beverage in which the beverage is filled in a beverage filling container in at least one of the following forms (I) and (II).
A beverage filling container (I) having a layer containing the hydrogen generating material.
A beverage filling container (II) in which a member containing the hydrogen generating material is present.

In the beverage filling container (I) used in an embodiment of the present invention, the layer containing the hydrogen generating material has only to be present at a position where hydrogen can be generated by coming into contact with a beverage, but is preferably present on an outermost surface of the interior of the container from the viewpoint of increasing a probability of contact with the filled beverage to reliably generate hydrogen.

From the viewpoint of ease of forming the layer, the layer containing the hydrogen generating material included in the beverage filling container (I) is preferably a layer formed from a resin composition containing the hydrogen generating material and a resin component.

In the beverage filling container (II) used in an embodiment of the present invention, the member containing the hydrogen generating material may be fixed to at least a part of an inner surface of the interior of the container interior, or may not be fixed to the inner surface of the container interior and may be in a state of floating in the beverage after the beverage is filled.

The member containing the hydrogen generating material is preferably a member formed from a resin composition containing the hydrogen generating material and a resin component.

Examples of the beverage of the packaged beverage according to an embodiment of the present invention include drinking water (soft drinks, mineral water, tap water and the like as defined in Ministry of Health, Labour and Welfare Notification No. 370, 1959), carbonated beverages (carbonated water, cola carbonated beverages, carbonated beverages containing juice such as fruit juice and vegetable juice, juice-flavored carbonated beverages such as fruit juice-flavored carbonated beverages and vegetable juice-flavored carbonated beverages, fruit-colored carbonated beverages, milk-containing carbonated beverages, non-alcoholic beer-taste beverages and the like), fruit beverages, vegetable beverages, fruit juice beverages, vegetable juice beverages, fruit juice-flavored beverages, vegetable juice-flavored beverages, fruit pulp beverages, flavored beverages, flavored syrups, acidic beverages produced from milk or dairy products, coffee beverages, caffeine beverages, tea-based beverages, soymilk beverages, and alcoholic beverages (alcohol-containing beer-taste beverages, liqueurs, wine (grape wine), fruit liquor, refined sake, low-malt beer, unrefined sake, distilled liquor, berry liquor, shochu, Japanese sake, Shaoxing rice wine, whisky, brandy, rum, gin, vodka, tequila, Makgeolli, and shochu-based beverages).

The real extract concentration of the packaged beverage according to an embodiment of the present invention and the beverage before being filled into the container may be 0.1 mass % or more, 0.2 mass % or more, 0.3 mass % or more, 0.4 mass % or more, 0.5 mass % or more, 0.6 mass % or more, 0.7 mass % or more, 0.8 mass % or more, 0.9 mass % or more, 1.0 mass % or more, 1.1 mass % or more, 1.2 mass % or more, 1.3 mass % or more, 1.4 mass % or more, 1.5 mass % or more, 1.6 mass % or more, 1.7 mass % or more, 1.8 mass % or more, 1.9 mass % or more, 2.0 mass % or more, 2.1 mass % or more, 2.2 mass % or more, 2.3 mass % or more, 2.4 mass % or more, 2.5 mass % or more, 2.6 mass % or more, 2.7 mass % or more, 2.8 mass % or more, 2.9 mass % or more, 3.0 mass % or more, 3.1 mass % or more, 3.2 mass % or more, 3.3 mass % or more, 3.4 mass % or more, 3.5 mass % or more, 3.6 mass % or more, 3.7 mass % or more, 3.8 mass % or more, 3.9 mass % or more, 4.0 mass % or more, 4.1 mass % or more, 4.2 mass % or more, 4.3 mass % or more, 4.4 mass % or more, 4.5 mass % or more, 4.6 mass % or more, 4.7 mass % or more, 4.8 mass % or more, 4.9 mass % or more, 5.0 mass % or more, 5.1 mass % or more, 5.2 mass % or more, 5.3 mass % or more, 5.4 mass % or more, 5.5 mass % or more, 5.6 mass % or more, 5.7 mass % or more, 5.8 mass % or more, 5.9 mass % or more, 6.0 mass % or more, 6.1 mass % or more, 6.2 mass % or more, 6.3 mass % or more, 6.4 mass % or more, 6.5 mass % or more, 6.6 mass % or more, 6.7 mass % or more, 6.8 mass % or more, 6.9 mass % or more, 7.0 mass % or more, 7.1 mass % or more, 7.2 mass % or more, 7.3 mass % or more, 7.4 mass % or more, 7.5 mass % or more, 7.6 mass % or more, 7.7 mass % or more, 7.8 mass % or more, 7.9 mass % or more, 8.0 mass % or more, 8.1 mass % or more, 8.2 mass % or more, 8.3 mass % or more, 8.4 mass % or more, 8.5 mass % or more, 8.6 mass % or more, 8.7 mass % or more, 8.8 mass % or more, 8.9 mass % or more, 9.0 mass % or more, 9.1 mass % or more, 9.2 mass % or more, 9.3 mass % or more, 9.4 mass % or more, 9.5 mass % or more, 9.6 mass % or more, 9.7 mass % or more, 9.8 mass % or more, 9.9 mass % or more, 10.0 mass % or more, 11.0 mass % or more, 12.0 mass % or more, 13.0 mass % or more, 14.0 mass % or more, 15.0 mass % or more, 16.0 mass % or more, 17.0 mass % or more, 18.0 mass % or more, 19.0 mass % or more, 20.0 mass % or more, 21.0 mass % or more, 22.0 mass % or more, 23.0 mass % or more, 24.0 mass % or more, 25.0 mass % or more, 26.0 mass % or more, 27.0 mass % or more, 28.0 mass % or more, 29.0 mass % or more, or 30.0 mass % or more.

The higher the real extract concentration of the packaged beverage and the beverage before being filled into the container, the stronger the flavor, and thus the larger the decrease in flavor over time. However, in the packaged beverage according to an embodiment of the present invention, the oxidation-reduction potential is adjusted to a predetermined value, and thus the effect of suppressing a decrease in flavor is more easily exhibited even in a beverage having a strong flavor.

The real extract concentration of the packaged beverage according to an embodiment of the present invention and the beverage before being filled into the container may be 40.0 mass % or less, 39.0 mass % or less, 38.0 mass % or less, 37.0 mass % or less, 36.0 mass % or less, 35.0 mass % or less, 34.0 mass % or less, 33.0 mass % or less, 32.0 mass % or less, 31.0 mass % or less, 30.0 mass % or less, 29.0 mass % or less, 28.0 mass % or less, 27.0 mass % or less, 26.0 mass % or less, 25.0 mass % or less, 24.0 mass % or less, 23.0 mass % or less, 22.0 mass % or less, 21.0 mass % or less, 20.0 mass % or less, 19.0 mass % or less, 18.0 mass % or less, 17.0 mass % or less, 16.0 mass % or less, 15.0 mass % or less, 14.0 mass % or less, 13.0 mass % or less, 12.0 mass % or less, 11.0 mass % or less, 10.0 mass % or less, 9.5 mass % or less, 9.0 mass % or less, 8.5 mass % or less, 8.0 mass % or less, 7.5 mass % or less, 7.0 mass % or less, 6.9 mass % or less, 6.8 mass % or less, 6.7 mass % or less, 6.6 mass % or less, 6.5 mass % or less, 6.4 mass % or less, 6.3 mass % or less, 6.2 mass % or less, 6.1 mass % or less, 6.0 mass % or less, 5.9 mass % or less, 5.8 mass % or less, 5.7 mass % or less, 5.6 mass % or less, 5.5 mass % or less, 5.4 mass % or less, 5.3 mass % or less, 5.2 mass % or less, 5.1 mass % or less, 5.0 mass % or less, 4.9 mass % or less, 4.8 mass % or less, 4.7 mass % or less, 4.6 mass % or less, 4.5 mass % or less, 4.4 mass % or less, 4.3 mass % or less, 4.2 mass % or less, 4.1 mass % or less, 4.0 mass % or less, 3.9 mass % or less, 3.8 mass % or less, 3.7 mass % or less, 3.6 mass % or less, 3.5 mass % or less, 3.4 mass % or less, 3.3 mass % or less, 3.2 mass % or less, 3.1 mass % or less, 3.0 mass % or less, 2.9 mass % or less, 2.8 mass % or less, 2.7 mass % or less, 2.6 mass % or less, 2.5 mass % or less, 2.4 mass % or less, 2.3 mass % or less, 2.2 mass % or less, 1.1 mass % or less, or 1.0 mass % or less.

In the present specification, the real extract concentration means an authentic (true) extract value (mass %) obtained by measuring a degassed sample according to 8.4.4 Alcolyzer Method in the analysis method (BCOJ Beer Analysis Method (published by The Brewing Society of Japan, edited by Brewers Association of Japan, Enlarged and Revised Edition of 2013)) defined by Brewery Convention of Japan, Brewers Association of Japan (BCOJ).

The packaged beverage according to an embodiment of the present invention may be a fermented beverage produced through a fermentation step using yeast or may be a non-fermented beverage.

The packaged beverage according to an embodiment of the present invention may be a sweetened beverage or may be a non-sweetened beverage.

The packaged beverage according to an embodiment of the present invention may be an extracted beverage, such as tea or coffee, or may be a non-extracted beverage.

The packaged beverage according to an embodiment of the present invention may be a milk beverage containing raw milk, powdered milk, or the like, or may be a non-milk beverage.

The packaged beverage according to an embodiment of the present invention may be an alcoholic beverage with an alcoholic strength of 1.0 (v/v) % or more or may be a non-alcoholic beverage with an alcoholic strength of less than 1.0 (v/v) %.

When the packaged beverage according to an embodiment of the present invention is an alcoholic beverage, the alcoholic strength thereof may be 1.0 (v/v) % or more, 1.2 (v/v) % or more, 1.4 (v/v) % or more, 1.6 (v/v) % or more, 1.8 (v/v) % or more, 2.0 (v/v) % or more, 2.2 (v/v) % or more, 2.4 (v/v) % or more, 2.6 (v/v) % or more, 2.8 (v/v) % or more, 3.0 (v/v) % or more, 3.2 (v/v) % or more, 3.4 (v/v) % or more, 3.6 (v/v) % or more, 3.8 (v/v) % or more, 4.0 (v/v) % or more, 4.2 (v/v) % or more, 4.4 (v/v) % or more, 4.6 (v/v) % or more, 4.8 (v/v) % or more, 5.0 (v/v) % or more, 5.2 (v/v) % or more, 5.4 (v/v) % or more, 5.6 (v/v) % or more, 5.8 (v/v) % or more, 6.0 (v/v) % or more, 6.2 (v/v) % or more, 6.4 (v/v) % or more, 6.6 (v/v) % or more, 6.8 (v/v) % or more, 7.0 (v/v) % or more, 7.2 (v/v) % or more, 7.4 (v/v) % or more, 7.6 (v/v) % or more, 7.8 (v/v) % or more, 8.0 (v/v) % or more, 8.2 (v/v) % or more, 8.4 (v/v) % or more, 8.6 (v/v) % or more, 8.8 (v/v) % or more, 9.0 (v/v) % or more, 9.2 (v/v) % or more, 9.4 (v/v) % or more, 9.6 (v/v) % or more, 9.8 (v/v) % or more, 10.0 (v/v) % or more, or 15.0 (v/v) % or more, and may be 99.0 (v/v) % or less, 90.0 (v/v) % or less, 80.0 (v/v) % or less, 70.0 (v/v) % or less, 60.0 (v/v) % or less, 50.0 (v/v) % or less, 40.0 (v/v) % or less, 30.0 (v/v) % or less, 25.0 (v/v) % or less, 20.0 (v/v) % or less, 19.8 (v/v) % or less, 19.6 (v/v) % or less, 19.4 (v/v) % or less, 19.2 (v/v) % or less, 19.0 (v/v) % or less, 18.8 (v/v) % or less, 18.6 (v/v) % or less, 18.4 (v/v) % or less, 18.2 (v/v) % or less, 18.0 (v/v) % or less, 17.8 (v/v) % or less, 17.6 (v/v) % or less, 17.4 (v/v) % or less, 17.2 (v/v) % or less, 17.0 (v/v) % or less, 16.8 (v/v) % or less, 16.6 (v/v) % or less, 16.4 (v/v) % or less, 16.2 (v/v) % or less, 16.0 (v/v) % or less, 15.8 (v/v) % or less, 15.6 (v/v) % or less, 15.4 (v/v) % or less, 15.2 (v/v) % or less, 15.0 (v/v) % or less, 14.8 (v/v) % or less, 14.6 (v/v) % or less, 14.4 (v/v) % or less, 14.2 (v/v) % or less, 14.0 (v/v) % or less, 13.8 (v/v) % or less, 13.6 (v/v) % or less, 13.4 (v/v) % or less, 13.2 (v/v) % or less, 13.0 (v/v) % or less, 12.8 (v/v) % or less, 12.6 (v/v) % or less, 12.4 (v/v) % or less, 12.2 (v/v) % or less, 12.0 (v/v) % or less, 11.8 (v/v) % or less, 11.6 (v/v) % or less, 11.4 (v/v) % or less, 11.2 (v/v) % or less, 11.0 (v/v) % or less, 10.8 (v/v) % or less, 10.6 (v/v) % or less, 10.4 (v/v) % or less, 10.2 (v/v) % or less, 10.0 (v/v) % or less, 9.8 (v/v) % or less, 9.6 (v/v) % or less, 9.4 (v/v) % or less, 9.2 (v/v) % or less, 9.0 (v/v) % or less, 8.8 (v/v) % or less, 8.6 (v/v) % or less, 8.4 (v/v) % or less, 8.2 (v/v) % or less, 8.0 (v/v) % or less, 7.8 (v/v) % or less, 7.6 (v/v) % or less, 7.4 (v/v) % or less, 7.2 (v/v) % or less, 7.0 (v/v) % or less, 6.8 (v/v) % or less, 6.6 (v/v) % or less, 6.4 (v/v) % or less, 6.2 (v/v) % or less, 6.0 (v/v) % or less, 5.8 (v/v) % or less, 5.6 (v/v) % or less, 5.4 (v/v) % or less, 5.2 (v/v) % or less, 5.0 (v/v) % or less, 4.8 (v/v) % or less, 4.6 (v/v) % or less, 4.4 (v/v) % or less, 4.2 (v/v) % or less, 4.0 (v/v) % or less, 3.8 (v/v) % or less, 3.6 (v/v) % or less, 3.4 (v/v) % or less, 3.2 (v/v) % or less, 3.0 (v/v) % or less, 2.8 (v/v) % or less, 2.6 (v/v) % or less, 2.4 (v/v) % or less, 2.2 (v/v) % or less, 2.0 (v/v) % or less, 1.8 (v/v) % or less, 1.6 (v/v) % or less, 1.4 (v/v) % or less, or 1.2 (v/v) % or less.

When the packaged beverage according to an embodiment of the present invention is a non-alcoholic beverage, the alcoholic strength of the non-alcoholic beverage according to an embodiment of the present invention may be less than 1.0 (v/v) %, 0.9 (v/v) % or less, 0.8 (v/v) % or less, 0.7 (v/v) % or less, 0.6 (v/v) % or less, 0.5 (v/v) % or less, 0.4 (v/v) % or less, 0.3 (v/v) % or less, 0.2 (v/v) % or less, 0.1 (v/v) % or less, 0.05 (v/v) % or less, 0.01 (v/v) % or less, 0.0050 (v/v) % or less, or 0.0025 (v/v) % or less, and may be 0.0000 (v/v) % or more, 0.00 (v/v) % or more, 0.0 (v/v) % or more, 0.1 (v/v) % or more, 0.2 (v/v) % or more, 0.3 (v/v) % or more, 0.4 (v/v) % or more, 0.5 (v/v) % or more, 0.6 (v/v) % or more, 0.7 (v/v) % or more, 0.8 (v/v) % or more, or 0.9 (v/v) % or more.

The packaged beverage according to an embodiment of the present invention may be a non-alcoholic beverage substantially free of alcohol.

The “non-alcoholic beverage substantially free of alcohol” does not exclude beverages containing a trace amount of alcohol that is undetectable. The non-alcoholic beverage also includes beverages whose alcoholic strength is 0 (v/v) % when the value is rounded off to the integer, beverages whose alcoholic strength is 0.0 (v/v) % when the value is rounded off to the first decimal place, and beverages whose alcoholic strength is 0.00 (v/v) % when the value is rounded off to the second decimal place.

The non-alcoholic beverage may be a non-sweet beverage, such as a non-alcoholic beer-taste beverage, or may be a sweet beverage, such as a soft drink.

In the present specification, the “alcoholic strength” or “alcohol content” refers to a content of ethanol and does not include aliphatic alcohols.

In addition, in the present specification, the “alcoholic strength” or “alcohol content” is expressed as a volume/volume percentage ((v/v) %) and can be measured by any known method, for example, with a vibrating densimeter. Specifically, the alcoholic strength can be determined by preparing a sample from the beverage by removing carbon dioxide gas through filtration or with ultrasonication, distilling the sample over direct heat, measuring the density of the resulting distillate at 15° C., and converting the density using “Table 2. Conversion Table of Alcohol Content, Density (15° C.), and Specific Gravity (15/15° C.)”, which is an attached table of the Official Analysis Method of the National Tax Agency (2007 National Tax Agency Order No. 6, revised: Jun. 22, 2007). In addition, a non-alcoholic beverage with an alcoholic strength of less than 1.0 (v/v) % can also be measured using a commercially available alcohol measuring instrument or gas chromatography.

The packaged beverage according to an embodiment of the present invention may be a beverage containing a high-intensity sweetener or may be a beverage with a limited content of a high-intensity sweetener.

The content of the high-intensity sweetener contained in the packaged beverage with a limited content of the high-intensity sweetener may be less than 1000 mass ppm, less than 100 mass ppm, less than 75 mass ppm, less than 50 mass ppm, less than 40 mass ppm, less than 30 mass ppm, less than 25 mass ppm, less than 20 mass ppm, less than 15 mass ppm, less than 10 mass ppm, less than 1 mass ppm, less than 100 mass ppb, less than 10 mass ppb, less than 1 mass ppb, less than 100 mass ppt, less than 10 mass ppt, or less than 1 mass ppt based on the total amount (100 mass %) of the packaged beverage.

Examples of the high-intensity sweetener include both natural high-intensity sweeteners and artificial high-intensity sweeteners, for example, rebaudioside A, rebaudioside B, rebaudioside C, rebaudioside D, rebaudioside E, rebaudioside F, dulcoside A, dulcoside B, rubusoside, stevia, stevioside, mogroside IV, mogroside V, monk fruit (Siraitia grosvenorii) sweetener, siamenoside, monatin and its salts (monatin SS, monatin RR, monatin RS, monatin SR), curculin, glycyrrhizinic acid and its salts, thaumatin, monellin, mabinlin, brazzein, hernandulcin, phyllodulcin, glycyphyllin, phlorizin, trilobatin, baiyunoside, osladin, erythritol, polypodoside A, pterocaryoside A, pterocaryoside B, mucrodioside, phlomisoside I, periandrin I, abrusoside A, and cyclocarioside I.

The packaged beverage according to an embodiment of the present invention may be a beverage containing rebaudioside A or may be a beverage with a limited content of rebaudioside A.

The content of rebaudioside A contained in the packaged beverage with a limited content of rebaudioside A may be less than 1000 mass ppm, less than 100 mass ppm, less than 10 mass ppm, less than 1 mass ppm, less than 100 mass ppb, less than 10 mass ppb, less than 1 mass ppb, less than 100 mass ppt, less than 10 mass ppt, or less than 1 mass ppt based on the total amount (100 mass %) of the packaged beverage.

The packaged beverage according to an embodiment of the present invention may be a beverage containing erythritol or may be a beverage with a limited content of erythritol.

The content of erythritol contained in the packaged beverage with a limited content of erythritol may be less than 1000 mass ppm, less than 100 mass ppm, less than 10 mass ppm, less than 1 mass ppm, less than 100 mass ppb, less than 10 mass ppb, less than 1 mass ppb, less than 100 mass ppt, less than 10 mass ppt, or less than 1 mass ppt based on the total amount (100 mass %) of the packaged beverage.

Since the oxidation-reduction potential of the packaged beverage according to an embodiment of the present invention is adjusted to a predetermined value or less, the packaged beverage can be a beverage with a reduced content of an antioxidant or a beverage substantially free of antioxidant.

The antioxidant is not particularly limited, and a substance used as an antioxidant in ordinary beer and low-malt beer can be used, and examples include ascorbic acid, erythorbic acid, and catechin. One of these antioxidants may be used alone, or two or more thereof may be used in combination.

In the packaged beverage according to an embodiment of the present invention, the content of the antioxidant may be 1.0 mass % or less, 9000 mass ppm or less, 8000 mass ppm or less, 7000 mass ppm or less, 6000 mass ppm or less, 5000 mass ppm or less, 4000 mass ppm or less, 3000 mass ppm or less, 2000 mass ppm or less, 1000 mass ppm or less, 900 mass ppm or less, 800 mass ppm or less, 700 mass ppm or less, 600 mass ppm or less, 500 mass ppm or less, 400 mass ppm or less, 300 mass ppm or less, 200 mass ppm or less, 100 mass ppm or less, 90 mass ppm or less, 80 mass ppm or less, 70 mass ppm or less, 60 mass ppm or less, 50 mass ppm or less, 40 mass ppm or less, 30 mass ppm or less, 20 mass ppm or less, 10 mass ppm or less, 9.0 mass ppm or less, 8.0 mass ppm or less, 7.0 mass ppm or less, 6.0 mass ppm or less, 5.0 mass ppm or less, 4.0 mass ppm or less, 3.0 mass ppm or less, 2.0 mass ppm or less, or 1.0 mass ppm or less based on the total amount (100 mass %) of the packaged beverage.

Since the oxidation-reduction potential of the packaged beverage according to an embodiment of the present invention is adjusted to a predetermined value or less by using the hydrogen generating material, it is not necessary to perform an electrolysis treatment, and the amount of oxygen that causes oxidation of the beverage (amount of dissolved oxygen) can be reduced.

In the packaged beverage according to an embodiment of the present invention, the amount of dissolved oxygen may be 14 mg/L or less, 12 mg/L or less, 10 mg/L or less, 8.0 mg/L or less, 6.0 mg/L or less, 5.0 mg/L or less, 4.0 mg/L or less, 3.0 mg/L or less, 2.0 mg/L or less, 1.9 mg/L or less, 1.8 mg/L or less, 1.7 mg/L or less, 1.6 mg/L or less, 1.5 mg/L or less, 1.4 mg/L or less, 1.3 mg/L or less, 1.2 mg/L or less, 1.1 mg/L or less, 1.0 mg/L or less, 0.90 mg/L or less, 0.80 mg/L or less, 0.70 mg/L or less, 0.60 mg/L or less, 0.50 mg/L or less, 0.40 mg/L or less, 0.30 mg/L or less, 0.20 mg/L or less, 0.10 mg/L or less, 0.090 mg/L or less, 0.080 mg/L or less, 0.070 mg/L or less, 0.060 mg/L or less, 0.050 mg/L or less, 0.040 mg/L or less, 0.030 mg/L or less, 0.020 mg/L or less, or 0.010 mg/L or less from the viewpoint of suppressing oxidation and making a beverage excellent in flavor.

The gas pressure of the packaged beverage according to an embodiment of the present invention may be 0.01 kg/cm² or more, 0.03 kg/cm² or more, 0.05 kg/cm² or more, 0.07 kg/cm² or more, 0.10 kg/cm² or more, 0.12 kg/cm² or more, 0.15 kg/cm² or more, 0.17 kg/cm² or more, 0.20 kg/cm² or more, 0.22 kg/cm² or more, 0.25 kg/cm² or more Upper, 0.27 kg/cm² or more, 0.30 kg/cm² or more, 0.32 kg/cm² or more, 0.35 kg/cm² or more, 0.37 kg/cm² or more, 0.40 kg/cm² or more, 0.42 kg/cm 2 or more, 0.45 kg/cm² or more, 0.47 kg/cm² or more, 0.50 kg/cm² or more, 0.52 kg/cm² or more, 0.55 kg/cm² or more, 0.57 kg/cm² or more, 0.60 kg/cm² or more, 0.62 kg/cm² or more, 0.65 kg/cm² or more, 0.67 kg/cm² or more, 0.70 kg/cm² or more, 0.72 kg/cm² or more, 0.75 kg/cm² or more, 0.77 kg/cm² or more, 0.80 kg/cm² or more, 0.82 kg/cm² or more, 0.85 kg/cm² or more, 0.87 kg/cm² or more, 0.90 kg/cm² or more, 0.92 kg/cm² or more, 0.95 kg/cm² or more, 0.97 kg/cm² or more, or 1.00 kg/cm² or more, and may be 5.00 kg/cm² or less, 4.70 kg/cm² or less, 4.50 kg/cm² or less, 4.20 kg/cm² or less, 4.00 kg/cm² or less, 3.70 kg/cm² or less, 3.50 kg/cm² or less, 3.20 kg/cm² or less, 3.00 kg/cm² or less, 2.70 kg/cm² or less, 2.50 kg/cm² or less, 2.20 kg/cm² or less, or 2.00 kg/cm² or less.

In the present specification, the gas pressure refers to the gas pressure in the container except in special cases.

The pressure can be measured by a method well-known to those skilled in the art, for example, using a method in which a sample adjusted to 20° C. is fixed to a gas internal pressure meter, the stopcock of the gas internal pressure meter is opened once to release the gas, the stopcock is closed again, the gas internal pressure meter is shaken, and a value when the pointer reaches a certain position is read; or using a commercially available gas pressure measuring instrument.

Among various beverages, a grain beverage and a beer-taste beverage contain various aroma components and are beverages in which the flavor affects the taste of the beverage. However, deterioration of the flavor over time is more likely to be perceived than that in other beverages. However, by adjusting the oxidation-reduction potential of the grain beverage or the beer-taste beverage to the above-described range, the deterioration of the flavor over time can be remarkably suppressed. Therefore, as an embodiment of the present invention, the following embodiments are also provided.
[1] A packaged beverage (1) in which a grain beverage is filled in a container, the packaged beverage (1) having an oxidation-reduction potential of 5.00 mV or less (packaged grain beverage).
[2] A packaged beverage (2) in which a beer-taste beverage is filled in a container, the packaged beverage (2) having an oxidation-reduction potential of 5.00 mV or less (packaged beer-taste beverage).

Examples of such a grain used in the grain beverage in the above embodiment [1] include barley and the like such as barley, wheat, rye, wild oats, oats, and adlay, rice (such as white rice and brown rice), corn, kaoliang, potato, legumes (such as soybeans and peas), buckwheat, sorghum, foxtail millet, Japanese millet, starch resulting therefrom, and extracts thereof. The barley or the like may be malt obtained by germinating seeds, drying the seeds, and removing roots. As the grain used in the grain beverage, only malt may be used, or malt and ungerminated barley or the like may be used in combination.

With respect to the packaged beverages (1) and (2), the various physical properties including the oxidation-reduction potential, the real extract concentration, the alcoholic strength, the content of antioxidant, the amount of dissolved oxygen and the like, and the embodiments of the constitution are as described above.

Hereinafter, when the beverage filled in the packaged beverage according to an embodiment of the present invention is a beer-taste beverage, a specific embodiment of the beer-taste beverage will be described in detail.

### 2 Beer-Taste Beverage

In the present specification, the “beer-taste beverage” refers to an alcohol-containing or non-alcoholic carbonated beverage with a beer-like flavor. Thus, the “beer-taste beverage” includes not only beer that is a fermented malt beverage obtained by fermenting malt, water, and, as necessary, hop or the like as raw materials using yeast but also carbonated beverages with a beer flavor. That is, in the present specification, unless otherwise noted, the “beer-taste beverage” also includes any carbonated beverage to which a beer flavoring containing an ester or a higher alcohol (e.g., isoamyl acetate, ethyl acetate, n-propanol, isobutanol, acetaldehyde, ethyl caproate, linalool, or 4-vinylguaiacol) is added and which has a beer flavor.

Also, the beer-taste beverage may be a fermented beverage that has undergone a yeast-based fermentation step or may be a non-fermented beverage that has not undergone a fermentation step.

Further, the beer-taste beverage may be an alcohol-containing beer-taste beverage with an alcoholic strength of 1.0 (v/v) % or more or may be a non-alcoholic beer-taste beverage with an alcoholic strength of less than 1.0 (v/v) %.

The alcoholic strength of the alcohol-containing beer-taste beverage may be 1.0 (v/v) % or more, 1.5 (v/v) % or more, 2.0 (v/v) % or more, 2.5 (v/v) % or more, 3.0 (v/v) % or more, 3.5 (v/v) % or more, 4.0 (v/v) % or more, 4.5 (v/v) % or more, 5.0 (v/v) % or more, 5.4 (v/v) % or more, or 5.7 (v/v) % or more from the viewpoint of making a beverage that can give a refreshing and stimulating feeling, and may be 20.0 (v/v) % or less, 17.0 (v/v) % or less, 15.0 (v/v) % or less, 12.0 (v/v) % or less, 10.0 (v/v) % or less, 9.0 (v/v) % or less, 8.0 (v/v) % or less, or 7.0 (v/v) % or less from the viewpoint of making a beer-taste beverage that is quaffable.

The alcoholic strength in the non-alcoholic beer-taste beverage may be less than 1.0 (v/v) %, 0.9 (v/v) % or less, 0.8 (v/v) % or less, 0.7 (v/v) % or less, 0.6 (v/v) % or less, 0.5 (v/v) % or less, 0.4 (v/v) % or less, 0.3 (v/v) % or less, 0.2 (v/v) % or less, 0.1 (v/v) % or less, 0.05 (v/v) % or less, 0.01 (v/v) % or less, 0.0050 (v/v) % or less, or 0.0025 (v/v) % or less, or the non-alcoholic beverage may be a non-alcoholic beer-taste beverage substantially free of alcohol.

The “non-alcoholic beer-taste beverage substantially free of alcohol” does not exclude beverages containing a trace amount of alcohol that is undetectable. The non-alcoholic beer-taste beverage also includes beverages whose alcoholic strength is 0 (v/v) % when the value is rounded off to the integer, beverages whose alcoholic strength is 0.0 (v/v) % when the value is rounded off to the first decimal place, and beverages whose alcoholic strength is 0.00 (v/v) % when the value is rounded off to the second decimal place.

The non-alcoholic beer-taste beverage may be a beverage with an alcoholic strength of 0.1 (v/v) % or more and less than 1.0 (v/v) %, 0.2 (v/v) % or more and less than 1.0 (v/v) %, 0.3 (v/v) % or more and less than 1.0 (v/v) %, 0.4 (v/v) % or more and less than 1.0 (v/v) %, 0.5 (v/v) % or more and less than 1.0 (v/v) %, 0.6 (v/v) % or more and less than 1.0 (v/v) %, 0.7 (v/v) % or more and less than 1.0 (v/v) %, 0.8 (v/v) % or more and less than 1.0 (v/v) %, or 0.9 (v/v) % or more and less than 1.0 (v/v) %.

The non-alcoholic beer-taste beverage may be a non-alcoholic fermented beer-taste beverage produced by removing the alcohol produced in the fermentation step after the fermentation step, may be a beverage produced by stopping the fermentation at a stage where the alcoholic strength is less than 1.0 (v/v) % in the yeast-based fermentation step, or may be a non-alcoholic non-fermented beer-taste beverage produced to have a beer-like flavor without performing a fermentation step. The non-alcoholic beer-taste beverage also includes a beer-taste soft drink.

In addition, the beer-taste beverage may be a beer-taste malt beverage made using malt as a raw material or may be a beer-taste malt-free beverage made without using malt. The beer-taste beverage is preferably a beer-taste malt beverage and more preferably a beer-taste barley malt beverage.

Furthermore, the beer-taste beverage may be an ale beer-taste beverage brewed through a fermentation step using top-fermenting yeast or may be a lager beer-taste beverage brewed through a fermentation step using bottom-fermenting yeast.

The beer-taste beverage may be a distilled liquor-containing beer-taste beverage containing a distilled liquor, such as spirits, whiskey, or shochu, and among them, a spirits-containing beer-taste beverage is preferred.

The beer-taste beverage may be a distilled liquor-free beer-taste beverage containing no distilled liquor or may be a spirits-free beer-taste beverage containing no spirits.

The beer-taste beverage according to a specific embodiment of the present invention may be a fermented beverage, may be an alcohol-containing fermented beverage, or may be a fermented malt beverage.

From the viewpoint of making a beverage with excellent taste typical of a beer-taste beverage, the malt proportion of the beer-taste beverage may be 10 mass % or more, 11 mass % or more, 12 mass % or more, 13 mass % or more, 14 mass % or more, 15 mass % or more, 16 mass % or more, 17 mass % or more, 18 mass % or more, 19 mass % or more, 20 mass % or more, 21 mass % or more, 22 mass % or more, 23 mass % or more, 24 mass % or more, 25 mass % or more, 26 mass % or more, 27 mass % or more, 28 mass % or more, 29 mass % or more, 30 mass % or more, 31 mass % or more, 32 mass % or more, 33 mass % or more, 34 mass % or more, 35 mass % or more, 36 mass % or more, 37 mass % or more, 38 mass % or more, 39 mass % or more, 40 mass % or more, 41 mass % or more, 42 mass % or more, 43 mass % or more, 44 mass % or more, 45 mass % or more, 46 mass % or more, 47 mass % or more, 48 mass % or more, 49 mass % or more, 50 mass % or more, 51 mass % or more, 52 mass % or more, 53 mass % or more, 54 mass % or more, 55 mass % or more, 56 mass % or more, 57 mass % or more, 58 mass % or more, 59 mass % or more, 60 mass % or more, 61 mass % or more, 62 mass % or more, 63 mass % or more, 64 mass % or more, 65 mass % or more, 66 mass % or more, 67 mass % or more, 68 mass % or more, 69 mass % or more, 70 mass % or more, 71 mass % or more, 72 mass % or more, 73 mass % or more, 74 mass % or more, 75 mass % or more, 76 mass % or more, 77 mass % or more, 78 mass % or more, 79 mass % or more, 80 mass % or more, 81 mass % or more, 82 mass % or more, 83 mass % or more, 84 mass % or more, 85 mass % or more, 86 mass % or more, 87 mass % or more, 88 mass % or more, 89 mass % or more, 90 mass % or more, 91 mass % or more, 92 mass % or more, 93 mass % or more, 94 mass % or more, 95 mass % or more, 96 mass % or more, 97 mass % or more, 98 mass % or more, or 99 mass % or more, and is 100 mass % or less, but from the viewpoint of making a beer-taste beverage that is quaffable, the malt proportion may be less than 100 mass %, 90 mass % or less, 89 mass % or less, 88 mass % or less, 87 mass % or less, 86 mass % or less, 85 mass % or less, 84 mass % or less, 83 mass % or less, 82 mass % or less, 81 mass % or less, 80 mass % or less, 79 mass % or less, 78 mass % or less, 77 mass % or less, 76 mass % or less, 75 mass % or less, 74 mass % or less, 73 mass % or less, 72 mass % or less, 71 mass % or less, 70 mass % or less, 69 mass % or less, 68 mass % or less, 67 mass % or less, 66 mass % or less, 65 mass % or less, 64 mass % or less, 63 mass % or less, 62 mass % or less, 61 mass % or less, 60 mass % or less, 59 mass % or less, 58 mass % or less, 57 mass % or less, 56 mass % or less, 55 mass % or less, 54 mass % or less, 53 mass % or less, 52 mass % or less, 51 mass % or less, 50 mass % or less, 49 mass % or less, 48 mass % or less, 47 mass % or less, 46 mass % or less, 45 mass % or less, 44 mass % or less, 43 mass % or less, 42 mass % or less, 41 mass % or less, 40 mass % or less, 39 mass % or less, 38 mass % or less, 37 mass % or less, 36 mass % or less, 35 mass % or less, 34 mass % or less, 33 mass % or less, 32 mass % or less, 31 mass % or less, 30 mass % or less, 29 mass % or less, 28 mass % or less, 27 mass % or less, 26 mass % or less, 25 mass % or less, 24 mass % or less, 23 mass % or less, 22 mass % or less, 21 mass % or less, 20 mass % or less, 19 mass % or less, 18 mass % or less, 17 mass % or less, 16 mass % or less, 15 mass % or less, 14 mass % or less, 13 mass % or less, 12 mass % or less, or 11 mass % or less.

In the present specification, the “malt proportion” means a value calculated according to the Interpretation Notice on the Liquor Tax Law and the Administrative Ordinance Related to Alcoholic Beverages and the like enforced on Apr. 1, 2018.

The content of free amino nitrogen (FAN) of the beer-taste beverage may be 0.1 mg/100 mL or more, 0.3 mg/100 mL or more, 0.5 mg/100 mL or more, 0.7 mg/100 mL or more, 1.0 mg/100 mL or more, 1.5 mg/100 mL or more, 2.0 mg/100 mL or more, 2.5 mg/100 mL or more, 3.0 mg/100 mL or more, 3.5 mg/100 mL or more, 4.0 mg/100 mL or more, 4.5 mg/100 mL or more, 5.0 mg/100 mL or more, 5.5 mg/100 mL or more, 6.0 mg/100 mL or more, 6.5 mg/100 mL or more, 7.0 mg/100 mL or more, 7.5 mg/100 mL or more, 8.0 mg/100 mL or more, 8.5 mg/100 mL or more, 9.0 mg/100 mL or more, 9.5 mg/100 mL or more, 10.0 mg/100 mL or more, or 10.5 mg/100 mL or more, and may be 40.0 mg/100 mL or less, 35.0 mg/100 mL or less, 30.0 mg/100 mL or less, 29.0 mg/100 mL or less, 28.0 mg/100 mL or less, 27.0 mg/100 mL or less, 26.0 mg/100 mL or less, 25.0 mg/100 mL or less, 24.0 mg/100 mL or less, 23.0 mg/100 mL or less, 22.0 mg/100 mL or less, 21.0 mg/100 mL or less, 20.0 mg/100 mL or less, 19.0 mg/100 mL or less, 18.0 mg/100 mL or less, 17.0 mg/100 mL or less, 16.0 mg/100 mL or less, 15.0 mg/100 mL or less, 14.0 mg/100 mL or less, 13.0 mg/100 mL or less, 12.0 mg/100 mL or less, or 11.0 mg/100 mL or less.

The content of FAN can be adjusted by appropriately setting the addition of diluting water or carbonated water, the types of raw materials (such as malt, corn grits, and sugar solution), the amounts of raw materials, the type of enzyme, the amount of enzyme added (also including a proteolytic enzyme), the timing of enzyme addition, the time for proteolysis in a preparation tank, the pH in a preparation tank, the pH in the preparation step (wort production step from feeding of malt until before addition of yeast), the time for wort filtration, the set temperature and holding time in each temperature region in preparation of wort, the boiling time and pH in the boiling step, the original wort extract concentration in the pre-fermentation liquid, the original wort extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), and the like.

In addition, in the present specification, the content of FAN can be measured, for example, by a method described in 8.18 Free Amino Nitrogen of Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

An apparent fermentation degree of the beer-taste beverage may be 0% or more, 5% or more, 10% or more, 15% or more, 20% or more, 25% or more, 30% or more, 35% or more, 40% or more, or 50% or more, 60% or more, 70% or more, 75% or more, 80% or more, 85% or more, 90% or more, 95% or more, 100% or more, or 111% or more, and may be 120% or less, 115% or less, 110% or less, 105% or less, 100% or less, 95% or less, 90% or less, 85% or less, 80% or less, 75% or less, 70% or less, 65% or less, 60% or less, or 55% or less.

The apparent fermentation degree can be adjusted by appropriately setting the addition of diluting water or carbonated water, the types of raw materials (such as malt, corn grits, and sugar solution), the amounts of raw materials, the type of enzyme, the amount of enzyme added (also including a saccharolytic enzyme or an isomerase), the temperature in enzymatic reaction, the timing of enzyme addition, the saccharification time, the pH during saccharification, the temperature during saccharification, the pH in the preparation step (wort production step from feeding of malt until before addition of yeast), the temperature in the preparation step, the time for wort filtration, the set temperature and holding time in each temperature region in preparation of wort (including during saccharification), the original wort extract concentration in the pre-fermentation liquid, the original wort extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), and the like.

In the present specification, the “apparent fermentation degree” means the proportion of the concentration of sugar that can be consumed by yeast as a nutrient source for alcoholic fermentation to the total concentration of sugar contained in the pre-fermentation liquid. For example, the apparent fermentation degree AA of the beer-taste beverage can be calculated from Formula (1) below.

$$AA ( \% ) = 100 \times ( P - Es ) / P \qquad Formula ( 1 )$$

In the above Formula (1), “P” represents an original extract concentration (original wort extract concentration) and can be measured by a method described in “BCOJ Beer Analysis Method (published by The Brewing Society of Japan, edited by Brewers Association of Japan, revised: Nov. 1, 2004)”.

“Es” represents an apparent extract concentration of the beer-taste beverage. The apparent extract concentration can be calculated from the following Formula (2), as described in, for example, “BCOJ Beer Analysis Method (published by The Brewing Society of Japan, edited by Brewers Association of Japan, revised: Nov. 1, 2004)”.

$$Es = - 460.234 + 662.649 \times D - 202.414 \times {D}^{2} \qquad Formula ( 2 )$$

In Formula (2), D is the specific gravity of a degassed beer-taste beverage.

The apparent extract concentration “Es” may have a negative value depending on D in Formula (2), and thus the calculated apparent fermentation degree may exceed 100%.

The sugar content of the beer-taste beverage may be 0.1 g/100 mL or more, 0.2 g/100 mL or more, 0.3 g/100 mL or more, 0.4 g/100 mL or more, 0.5 g/100 mL or more, 0.6 g/100 mL or more, 0.7 g/100 mL or more, 0.8 g/100 mL or more, 0.9 g/100 mL or more, 1.0 g/100 mL or more, 1.1 g/100 mL or more, 1.2 g/100 mL or more, 1.3 g/100 mL or more, 1.4 g/100 mL or more, 1.5 g/100 mL or more, 1.6 g/100 mL or more, 1.7 g/100 mL or more, 1.8 g/100 mL or more, 1.9 g/100 mL or more, 2.0 g/100 mL or more, 2.1 g/100 mL or more, 2.2 g/100 mL or more, 2.3 g/100 mL or more, 2.4 g/100 mL or more, 2.5 g/100 mL or more, 2.6 g/100 mL or more, 2.7 g/100 mL or more, 2.8 g/100 mL or more, 2.9 g/100 mL or more, 3.0 g/100 mL or more, 3.1 g/100 mL or more, 3.2 g/100 mL or more, 3.3 g/100 mL or more, 3.4 g/100 mL or more, 3.5 g/100 mL or more, 3.6 g/100 mL or more, 3.7 g/100 mL or more, 3.8 g/100 mL or more, 3.9 g/100 mL or more, 4.0 g/100 mL or more, 4.1 g/100 mL or more, 4.2 g/100 mL or more, 4.3 g/100 mL or more, 4.4 g/100 mL or more, 4.5 g/100 mL or more, 4.6 g/100 mL or more, 4.7 g/100 mL or more, 4.8 g/100 mL or more, 4.9 g/100 mL or more, 5.0 g/100 mL or more, 5.1 g/100 mL or more, 5.2 g/100 mL or more, 5.3 g/100 mL or more, 5.4 g/100 mL or more, 5.5 g/100 mL or more, 5.6 g/100 mL or more, 5.7 g/100 mL or more, 5.8 g/100 mL or more, 5.9 g/100 mL or more, 6.0 g/100 mL or more, 6.1 g/100 mL or more, 6.2 g/100 mL or more, 6.3 g/100 mL or more, 6.4 g/100 mL or more, 6.5 g/100 mL or more, 6.6 g/100 mL or more, 6.7 g/100 mL or more, 6.8 g/100 mL or more, 6.9 g/100 mL or more, 7.0 g/100 mL or more, 7.1 g/100 mL or more, 7.2 g/100 mL or more, 7.3 g/100 mL or more, 7.4 g/100 mL or more, 7.5 g/100 mL or more, 7.6 g/100 mL or more, 7.7 g/100 mL or more, 7.8 g/100 mL or more, 7.9 g/100 mL or more, 8.0 g/100 mL or more, 8.1 g/100 mL or more, 8.2 g/100 mL or more, 8.3 g/100 mL or more, 8.4 g/100 mL or more, 8.5 g/100 mL or more, 8.6 g/100 mL or more, 8.7 g/100 mL or more, 8.8 g/100 mL or more, 8.9 g/100 mL or more, 9.0 g/100 mL or more, 9.1 g/100 mL or more, 9.2 g/100 mL or more, 9.3 g/100 mL or more, 9.4 g/100 mL or more, 9.5 g/100 mL or more, 9.6 g/100 mL or more, 9.7 g/100 mL or more, 9.8 g/100 mL or more, 9.9 g/100 mL or more, 10.0 g/100 mL or more, 10.1 g/100 mL or more, 10.2 g/100 mL or more, 10.3 g/100 mL or more, 10.4 g/100 mL or more, 10.5 g/100 mL or more, 10.6 g/100 mL or more, 10.7 g/100 mL or more, 10.8 g/100 mL or more, 10.9 g/100 mL or more, 11.0 g/100 mL or more, 11.1 g/100 mL or more, 11.2 g/100 mL or more, 11.3 g/100 mL or more, 11.4 g/100 mL or more, 11.5 g/100 mL or more, 11.6 g/100 mL or more, 11.7 g/100 mL or more, 11.8 g/100 mL or more, 11.9 g/100 mL or more, 12.0 g/100 mL or more, 12.1 g/100 mL or more, 12.2 g/100 mL or more, 12.3 g/100 mL or more, 12.4 g/100 mL or more, 12.5 g/100 mL or more, 12.6 g/100 mL or more, 12.7 g/100 mL or more, 12.8 g/100 mL or more, 12.9 g/100 mL or more, 13.0 g/100 mL or more, 13.1 g/100 mL or more, 13.2 g/100 mL or more, 13.3 g/100 mL or more, 13.4 g/100 mL or more, 13.5 g/100 mL or more, 13.6 g/100 mL or more, 13.7 g/100 mL or more, 13.8 g/100 mL or more, 13.9 g/100 mL or more, 14.0 g/100 mL or more, 14.1 g/100 mL or more, 14.2 g/100 mL or more, 14.3 g/100 mL or more, 14.4 g/100 mL or more, 14.5 g/100 mL or more, 14.6 g/100 mL or more, 14.7 g/100 mL or more, 14.8 g/100 mL or more, 14.9 g/100 mL or more, 15.0 g/100 mL or more, 15.1 g/100 mL or more, 15.2 g/100 mL or more, 15.3 g/100 mL or more, 15.4 g/100 mL or more, 15.5 g/100 mL or more, 15.6 g/100 mL or more, 15.7 g/100 mL or more, 15.8 g/100 mL or more, 15.9 g/100 mL or more, 16.0 g/100 mL or more, 16.1 g/100 mL or more, 16.2 g/100 mL or more, 16.3 g/100 mL or more, 16.4 g/100 mL or more, 16.5 g/100 mL or more, 16.6 g/100 mL or more, 16.7 g/100 mL or more, 16.8 g/100 mL or more, 16.9 g/100 mL or more, 17.0 g/100 mL or more, 17.1 g/100 mL or more, 17.2 g/100 mL or more, 17.3 g/100 mL or more, 17.4 g/100 mL or more, 17.5 g/100 mL or more, 17.6 g/100 mL or more, 17.7 g/100 mL or more, 17.8 g/100 mL or more, 17.9 g/100 mL or more, 18.0 g/100 mL or more, 18.1 g/100 mL or more, 18.2 g/100 mL or more, 18.3 g/100 mL or more, 18.4 g/100 mL or more, 18.5 g/100 mL or more, 18.6 g/100 mL or more, 18.7 g/100 mL or more, 18.8 g/100 mL or more, 18.9 g/100 mL or more, 19.0 g/100 mL or more, 19.1 g/100 mL or more, 19.2 g/100 mL or more, 19.3 g/100 mL or more, 19.4 g/100 mL or more, 19.5 g/100 mL or more, 19.6 g/100 mL or more, 19.7 g/100 mL or more, 19.8 g/100 mL or more, or 19.9 g/100 mL or more.

The sugar content of the beer-taste beverage may be 20.0 g/100 mL or less, 19.9 g/100 mL or less, 19.8 g/100 mL or less, 19.7 g/100 mL or less, 19.6 g/100 mL or less, 19.5 g/100 mL or less, 19.4 g/100 mL or less, 19.3 g/100 mL or less, 19.2 g/100 mL or less, 19.1 g/100 mL or less, 19.0 g/100 mL or less, 18.9 g/100 mL or less, 18.8 g/100 mL or less, 18.7 g/100 mL or less, 18.6 g/100 mL or less, 18.5 g/100 mL or less, 18.4 g/100 mL or less, 18.3 g/100 mL or less, 18.2 g/100 mL or less, 18.1 g/100 mL or less, 18.0 g/100 mL or less, 17.9 g/100 mL or less, 17.8 g/100 mL or less, 17.7 g/100 mL or less, 17.6 g/100 mL or less, 17.5 g/100 mL or less, 17.4 g/100 mL or less, 17.3 g/100 mL or less, 17.2 g/100 mL or less, 17.1 g/100 mL or less, 17.0 g/100 mL or less, 16.9 g/100 mL or less, 16.8 g/100 mL or less, 16.7 g/100 mL or less, 16.6 g/100 mL or less, 16.5 g/100 mL or less, 16.4 g/100 mL or less, 16.3 g/100 mL or less, 16.2 g/100 mL or less, 16.1 g/100 mL or less, 16.0 g/100 mL or less, 15.9 g/100 mL or less, 15.8 g/100 mL or less, 15.7 g/100 mL or less, 15.6 g/100 mL or less, 15.5 g/100 mL or less, 15.4 g/100 mL or less, 15.3 g/100 mL or less, 15.2 g/100 mL or less, 15.1 g/100 mL or less, 15.0 g/100 mL or less, 14.9 g/100 mL or less, 14.8 g/100 mL or less, 14.7 g/100 mL or less, 14.6 g/100 mL or less, 14.5 g/100 mL or less, 14.4 g/100 mL or less, 14.3 g/100 mL or less, 14.2 g/100 mL or less, 14.1 g/100 mL or less, 14.0 g/100 mL or less, 13.9 g/100 mL or less, 13.8 g/100 mL or less, 13.7 g/100 mL or less, 13.6 g/100 mL or less, 13.5 g/100 mL or less, 13.4 g/100 mL or less, 13.3 g/100 mL or less, 13.2 g/100 mL or less, 13.1 g/100 mL or less, 13.0 g/100 mL or less, 12.9 g/100 mL or less, 12.8 g/100 mL or less, 12.7 g/100 mL or less, 12.6 g/100 mL or less, 12.5 g/100 mL or less, 12.4 g/100 mL or less, 12.3 g/100 mL or less, 12.2 g/100 mL or less, 12.1 g/100 mL or less, 12.0 g/100 mL or less, 11.9 g/100 mL or less, 11.8 g/100 mL or less, 11.7 g/100 mL or less, 11.6 g/100 mL or less, 11.5 g/100 mL or less, 11.4 g/100 mL or less, 11.3 g/100 mL or less, 11.2 g/100 mL or less, 11.1 g/100 mL or less, 11.0 g/100 mL or less, 10.9 g/100 mL or less, 10.8 g/100 mL or less, 10.7 g/100 mL or less, 10.6 g/100 mL or less, 10.5 g/100 mL or less, 10.4 g/100 mL or less, 10.3 g/100 mL or less, 10.2 g/100 mL or less, 10.1 g/100 mL or less, 10.0 g/100 mL or less, 9.9 g/100 mL or less, 9.8 g/100 mL or less, 9.7 g/100 mL or less, 9.6 g/100 mL or less, 9.5 g/100 mL or less, 9.4 g/100 mL or less, 9.3 g/100 mL or less, 9.2 g/100 mL or less, 9.1 g/100 mL or less, 9.0 g/100 mL or less, 8.9 g/100 mL or less, 8.8 g/100 mL or less, 8.7 g/100 mL or less, 8.6 g/100 mL or less, 8.5 g/100 mL or less, 8.4 g/100 mL or less, 8.3 g/100 mL or less, 8.2 g/100 mL or less, 8.1 g/100 mL or less, 8.0 g/100 mL or less, 7.9 g/100 mL or less, 7.8 g/100 mL or less, 7.7 g/100 mL or less, 7.6 g/100 mL or less, 7.5 g/100 mL or less, 7.4 g/100 mL or less, 7.3 g/100 mL or less, 7.2 g/100 mL or less, 7.1 g/100 mL or less, 7.0 g/100 mL or less, 6.9 g/100 mL or less, 6.8 g/100 mL or less, 6.7 g/100 mL or less, 6.6 g/100 mL or less, 6.5 g/100 mL or less, 6.4 g/100 mL or less, 6.3 g/100 mL or less, 6.2 g/100 mL or less, 6.1 g/100 mL or less, 6.0 g/100 mL or less, 5.9 g/100 mL or less, 5.8 g/100 mL or less, 5.7 g/100 mL or less, 5.6 g/100 mL or less, 5.5 g/100 mL or less, 5.4 g/100 mL or less, 5.3 g/100 mL or less, 5.2 g/100 mL or less, 5.1 g/100 mL or less, 5.0 g/100 mL or less, 4.9 g/100 mL or less, 4.8 g/100 mL or less, 4.7 g/100 mL or less, 4.6 g/100 mL or less, 4.5 g/100 mL or less, 4.4 g/100 mL or less, 4.3 g/100 mL or less, 4.2 g/100 mL or less, 4.1 g/100 mL or less, 4.0 g/100 mL or less, 3.9 g/100 mL or less, 3.8 g/100 mL or less, 3.7 g/100 mL or less, 3.6 g/100 mL or less, 3.5 g/100 mL or less, 3.4 g/100 mL or less, 3.3 g/100 mL or less, 3.2 g/100 mL or less, 3.1 g/100 mL or less, 3.0 g/100 mL or less, 2.9 g/100 mL or less, 2.8 g/100 mL or less, 2.7 g/100 mL or less, 2.6 g/100 mL or less, 2.5 g/100 mL or less, 2.4 g/100 mL or less, 2.3 g/100 mL or less, 2.2 g/100 mL or less, 2.1 g/100 mL or less, or 2.0 g/100 mL or less.

In addition, the beer-taste beverage may be a low-sugar beverage or a sugar-free beverage, and the specific sugar content may be less than 2.0 g/100 mL, 1.9 g/100 mL or less, 1.8 g/100 mL or less, 1.7 g/100 mL or less, 1.6 g/100 mL or less, 1.5 g/100 mL or less, 1.4 g/100 mL or less, 1.3 g/100 mL or less, 1.2 g/100 mL or less, 1.1 g/100 mL or less, 1.0 g/100 mL or less, less than 1.0 g/100 mL, 0.9 g/100 mL or less, 0.8 g/100 mL or less, 0.7 g/100 mL or less, 0.6 g/100 mL or less, 0.5 g/100 mL or less, less than 0.5 g/100 mL, 0.4 g/100 mL or less, 0.3 g/100 mL or less, 0.2 g/100 mL or less.

The sugar content can be adjusted by appropriately setting the addition of diluting water or carbonated water, the types of raw materials (such as malt, corn grits, and sugar solution), the amounts of raw materials, the type of enzyme, the amount of enzyme added (also including a saccharolytic enzyme or an isomerase), the timing of enzyme addition, the saccharification time, the pH during saccharification, the pH in the preparation step (wort production step from feeding of malt until before addition of yeast), the time for wort filtration, the set temperature and holding time in each temperature region in preparation of wort (including during saccharification), the original wort extract concentration in the pre-fermentation liquid, the original wort extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), and the like.

In addition, the “sugar” in the present specification refers to a sugar based on the Nutrition Labeling Standards for Foods (Ministry of Health, Labour and Welfare Notification No. 176, 2003, Consumer Affairs Agency Notification No. 8, Partial Revision, Sep. 27, 2013) and specifically means a material in which protein, lipid, dietary fiber, ash, alcohol content, and water have been removed from the target food. Thus, the amount of sugar in a food can be calculated by subtracting the amounts of protein, lipid, dietary fiber, ash, and water from the weight of the food.

Here, the amounts of protein, lipid, dietary fiber, ash, and water can be measured by the methods described in the Nutrition Labeling Standards. Specifically, the amount of protein can be measured by a method of quantitative conversion of nitrogen, the amount of lipid can be measured by an ether extraction method, the amount of dietary fiber can be measured by the Prosky method, the amount of ash can be measured by a direct ashing method, and the amount of water can be measured by a method of heating and drying under reduced pressure.

The content of dietary fiber in the beer-taste beverage may be 0 g/100 mL or more, 0.1 g/100 mL or more, 0.2 g/100 mL or more, 0.3 g/100 mL or more, 0.4 g/100 mL or more, or 0.5 g/100 mL or more, and 5.0 g/100 mL or less, 4.5 g/100 mL or less, 4.0 g/100 mL or less, 3.5 g/100 mL or less, 3.0 g/100 mL or less, 2.5 g/100 mL or less, 2.0 g/100 mL or less, 1.5 g/100 L or less, or 1.0 g/100 mL or less.

“Dietary fiber” is a general term for indigestible components which are contained in foods and are not digested or hardly digested by digestive enzymes in the human stomach, intestine, or the like, and is broadly divided into water-soluble dietary fiber, which is water-soluble, and insoluble dietary fiber, which is insoluble in water.

Examples of the water-soluble dietary fiber include indigestible dextrin, polydextrose, isomaltodextrin, guar gum degradation products, pectin, glucomannan, alginic acid, laminarin, fucoidan, and carrageenan. In addition, examples of the insoluble dietary fiber include cellulose, hemicellulose, lignin, chitin, and chitosan.

In the present invention, the dietary fiber may be not only a dietary fiber incorporated by addition but also a dietary fiber originating from a raw material or a dietary fiber originating from an animal or plant, and the origin is not particularly limited.

The content of dietary fiber can be adjusted by appropriately setting the addition of diluting water or carbonated water, the types of raw materials (such as malt, corn grits, and sugar solution), the amounts of raw materials, the type of enzyme, the amount of enzyme added (also including a saccharolytic enzyme or an isomerase), the timing of enzyme addition, the saccharification time, the pH during saccharification, the pH in the preparation step (wort production step from feeding of malt until before addition of yeast), the time for wort filtration, the set temperature and holding time in each temperature region in preparation of wort (including during saccharification), the original wort extract concentration in the pre-fermentation liquid, the original wort extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), and the like.

In addition, in the present specification, the content of dietary fiber can be measured by the Prosky method.

The total polyphenol amount of the beer-taste beverage may be 0 mass ppm or more, 5 mass ppm or more, 10 mass ppm or more, 15 mass ppm or more, 20 mass ppm or more, 25 mass ppm or more, 30 mass ppm or more, 35 mass ppm or more, 40 mass ppm or more, 45 mass ppm or more, 50 mass ppm or more, 55 mass ppm or more, 60 mass ppm or more, 65 mass ppm or more, 70 mass ppm or more, 75 mass ppm or more, 80 mass ppm or more, 85 mass ppm or more, 90 mass ppm or more, 95 mass ppm or more, 100 mass ppm or more, 110 mass ppm or more, 120 mass ppm or more, 130 mass ppm or more, 140 mass ppm or more, 150 mass ppm or more, 160 mass ppm or more, or 170 mass ppm or more, and may be 300 mass ppm or less, 290 mass ppm or less, 280 mass ppm or less, 270 mass ppm or less, 260 mass ppm or less, 250 mass ppm or less, 240 mass ppm or less, 230 mass ppm or less, 220 mass ppm or less, 210 mass ppm or less, 200 mass ppm or less, 190 mass ppm or less, or 180 mass ppm or less.

The total polyphenol amount can be performed by appropriately setting the addition of diluting water or carbonated water, the types of raw materials (such as malt, corn grits, and sugar solution), the amounts of raw materials, the type of enzyme, the amount of enzyme added, the timing of enzyme addition, the pH in a preparation tank, the pH in the preparation step (wort production step from feeding of malt until before addition of yeast), the time for wort filtration, the set temperature and holding time in each temperature region in preparation of wort (including during saccharification), the original wort extract concentration in the pre-fermentation liquid, the original wort extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), and the like.

In addition, the total polyphenol amount can be controlled by adjusting the usage amount of a raw material with a high polyphenol content, such as barley malt or malt husks (hulls). Specifically, the total polyphenol amount can be increased by increasing the usage amount of a raw material with a high polyphenol content, such as malt.

In addition, in the present specification, the total polyphenol amount can be measured, for example, by a method described in Revised BCOJ Beer Analysis Method (published by Public Interest Incorporated Foundation, The Brewing Society of Japan, edited by Analysis Committee, Brewery Convention of Japan, Brewers Association of Japan, Enlarged and Revised Edition of 2013).

The content of proline in the beer-taste beverage may be 0.1 mg/100 mL or more, 0.5 mg/100 mL or more, 1.0 mg/100 mL or more, 2.0 mg/100 mL or more, 3.0 mg/100 mL or more, 5.0 mg/100 mL or more, 7.0 mg/100 mL or more, 10.0 mg/100 mL or more, 12.0 mg/100 mL or more, 15.0 mg/100 mL or more, 17.0 mg/100 mL or more, 20.0 mg/100 mL or more, 25.0 mg/100 mL or more, 30.0 mg/100 mL or more, 35.0 mg/100 mL or more, 40.0 mg/100 mL or more, 45.0 mg/100 mL or more, 50.0 mg/100 mL or more, 55.0 mg/100 mL or more, 60.0 mg/100 mL or more, 65.0 mg/100 mL or more, 70.0 mg/100 mL or more, 75.0 mg/100 mL or more, 80.0 mg/100 mL or more, 85.0 mg/100 mL or more, 90.0 mg/100 mL or more, 95.0 mg/100 mL or more, 100 mg/100 mL or more, 105 mg/100 mL or more, 110 mg/100 mL or more, 115 mg/100 mL or more, 120 mg/100 mL or more, 125 mg/100 mL or more, 130 mg/100 mL or more, 135 mg/100 mL or more, 140 mg/100 mL or more, 145 mg/100 mL or more, 150 mg/100 mL or more, 155 mg/100 mL or more, 160 mg/100 mL or more, 165 mg/100 mL or more, 170 mg/100 mL or more, 175 mg/100 mL or more, 180 mg/100 mL or more, 185 mg/100 mL or more, 190 mg/100 mL or more, 195 mg/100 mL or more, 200 mg/100 mL or more, 205 mg/100 mL or more, 210 mg/100 mL or more, 215 mg/100 mL or more, 220 mg/100 mL or more, 225 mg/100 mL or more, 230 mg/100 mL or more, 235 mg/100 mL or more, 240 mg/100 mL or more, 245 mg/100 mL or more, 250 mg/100 mL or more, 255 mg/100 mL or more, 260 mg/100 mL or more, 265 mg/100 mL or more, 270 mg/100 mL or more, 275 mg/100 mL or more, 280 mg/100 mL or more, 285 mg/100 mL or more, 290 mg/100 mL or more, or 295 mg/100 mL or more, and may be 300 mg/100 mL or less, 295 mg/100 mL or less, 290 mg/100 mL or less, 285 mg/100 mL or less, 280 mg/100 mL or less, 275 mg/100 mL or less, 270 mg/100 mL or less, 265 mg/100 mL or less, 260 mg/100 mL or less, 255 mg/100 mL or less, 250 mg/100 mL or less, 245 mg/100 mL or less, 240 mg/100 mL or less, 235 mg/100 mL or less, 230 mg/100 mL or less, 225 mg/100 mL or less, 220 mg/100 mL or less, 215 mg/100 mL or less, 210 mg/100 mL or less, 205 mg/100 mL or less, 200 mg/100 mL or less, 195 mg/100 mL or less, 190 mg/100 mL or less, 185 mg/100 mL or less, 180 mg/100 mL or less, 175 mg/100 mL or less, 170 mg/100 mL or less, 165 mg/100 mL or less, 160 mg/100 mL or less, 155 mg/100 mL or less, 150 mg/100 mL or less, 145 mg/100 mL or less, 140 mg/100 mL or less, 135 mg/100 mL or less, 130 mg/100 mL or less, 125 mg/100 mL or less, 120 mg/100 mL or less, 115 mg/100 mL or less, 110 mg/100 mL or less, 105 mg/100 mL or less, 100 mg/100 mL or less, 95.0 mg/100 mL or less, 90.0 mg/100 mL or less, 85.0 mg/100 mL or less, 80.0 mg/100 mL or less, 75.0 mg/100 mL or less, 70.0 mg/100 mL or less, 65.0 mg/100 mL or less, 60.0 mg/100 mL or less, 55.0 mg/100 mL or less, 50.0 mg/100 mL or less, 45.0 mg/100 mL or less, 40.0 mg/100 mL or less, 35.0 mg/100 mL or less, 30.0 mg/100 mL or less, 25.0 mg/100 mL or less, 22.0 mg/100 mL or less, 20.0 mg/100 mL or less, 18.0 mg/100 mL or less, 16.0 mg/100 mL or less, 14.0 mg/100 mL or less, 12.0 mg/100 mL or less, 10.0 mg/100 mL or less, 8.0 mg/100 mL or less, 6.0 mg/100 mL or less, or 5.0 mg/100 mL or less.

Proline is a type of amino acid that is contained in a relatively large amount in barley and the like, such as malt, and whose content does not change much before and after the fermentation step. Adjusting the content of proline results in a beer-taste beverage with even better taste.

In the present specification, the content of proline can be measured, for example, using an automatic amino acid analyzer L-8800A available from Hitachi, Ltd. or the like.

From the viewpoint of making a beverage with excellent taste typical of a beer-taste beverage, the original wort extract concentration of the beer-taste beverage may be 5.0 mass % or more, 5.1 mass % or more, 5.2 mass % or more, 5.3 mass % or more, 5.4 mass % or more, 5.5 mass % or more, 5.6 mass % or more, 5.7 mass % or more, 5.8 mass % or more, 5.9 mass % or more, 6.0 mass % or more, 6.1 mass % or more, 6.2 mass % or more, 6.3 mass % or more, 6.4 mass % or more, 6.5 mass % or more, 6.6 mass % or more, 6.7 mass % or more, 6.8 mass % or more, 6.9 mass % or more, 7.0 mass % or more, 7.1 mass % or more, 7.2 mass % or more, 7.3 mass % or more, 7.4 mass % or more, 7.5 mass % or more, 7.6 mass % or more, 7.7 mass % or more, 7.8 mass % or more, 7.9 mass % or more, 8.0 mass % or more, 8.1 mass % or more, 8.2 mass % or more, 8.3 mass % or more, 8.4 mass % or more, 8.5 mass % or more, 8.6 mass % or more, 8.7 mass % or more, 8.8 mass % or more, 8.9 mass % or more, 9.0 mass % or more, 9.1 mass % or more, 9.2 mass % or more, 9.3 mass % or more, 9.4 mass % or more, 9.5 mass % or more, 9.6 mass % or more, 9.7 mass % or more, 9.8 mass % or more, 9.9 mass % or more, 10.0 mass % or more, 10.1 mass % or more, 10.2 mass % or more, 10.3 mass % or more, 10.4 mass % or more, 10.5 mass % or more, 10.6 mass % or more, 10.7 mass % or more, 10.8 mass % or more, 10.9 mass % or more, 11.0 mass % or more, 11.1 mass % or more, 11.2 mass % or more, 11.3 mass % or more, 11.4 mass % or more, 11.5 mass % or more, 11.6 mass % or more, 11.7 mass % or more, 11.8 mass % or more, 11.9 mass % or more, 12.0 mass % or more, 12.1 mass % or more, 12.2 mass % or more, 12.3 mass % or more, 12.4 mass % or more, 12.5 mass % or more, 12.6 mass % or more, 12.7 mass % or more, 12.8 mass % or more, 12.9 mass % or more, 13.0 mass % or more, 13.1 mass % or more, 13.2 mass % or more, 13.3 mass % or more, 13.4 mass % or more, 13.5 mass % or more, 13.6 mass % or more, 13.7 mass % or more, 13.8 mass % or more, 13.9 mass % or more, 14.0 mass % or more, 14.1 mass % or more, 14.2 mass % or more, 14.3 mass % or more, 14.4 mass % or more, 14.5 mass % or more, 14.6 mass % or more, 14.7 mass % or more, 14.8 mass % or more, 14.9 mass % or more, 15.0 mass % or more, 15.1 mass % or more, 15.2 mass % or more, 15.3 mass % or more, 15.4 mass % or more, 15.5 mass % or more, 15.6 mass % or more, 15.7 mass % or more, 15.8 mass % or more, 15.9 mass % or more, 16.0 mass % or more, 16.1 mass % or more, 16.2 mass % or more, 16.3 mass % or more, 16.4 mass % or more, 16.5 mass % or more, 16.6 mass % or more, 16.7 mass % or more, 16.8 mass % or more, 16.9 mass % or more, 17.0 mass % or more, 17.1 mass % or more, 17.2 mass % or more, 17.3 mass % or more, 17.4 mass % or more, 17.5 mass % or more, 17.6 mass % or more, 17.7 mass % or more, 17.8 mass % or more, 17.9 mass % or more, 18.0 mass % or more, 18.1 mass % or more, 18.2 mass % or more, 18.3 mass % or more, 18.4 mass % or more, 18.5 mass % or more, 18.6 mass % or more, 18.7 mass % or more, 18.8 mass % or more, 18.9 mass % or more, 19.0 mass % or more, 19.1 mass % or more, 19.2 mass % or more, 19.3 mass % or more, 19.4 mass % or more, 19.5 mass % or more, 19.6 mass % or more, 19.7 mass % or more, 19.8 mass % or more, or 19.9 mass % or more, and from the view point of making a beverage with distinguished refreshing aroma and sweet aroma typical of a beer-taste beverage, the original wort extract concentration may be 20.0 mass % or less, 19.9 mass % or less, 19.8 mass % or less, 19.7 mass % or less, 19.6 mass % or less, 19.5 mass % or less, 19.4 mass % or less, 19.3 mass % or less, 19.2 mass % or less, 19.1 mass % or less, 19.0 mass % or less, 18.9 mass % or less, 18.8 mass % or less, 18.7 mass % or less, 18.6 mass % or less, 18.5 mass % or less, 18.4 mass % or less, 18.3 mass % or less, 18.2 mass % or less, 18.1 mass % or less, 18.0 mass % or less, 17.9 mass % or less, 17.8 mass % or less, 17.7 mass % or less, 17.6 mass % or less, 17.5 mass % or less, 17.4 mass % or less, 17.3 mass % or less, 17.2 mass % or less, 17.1 mass % or less, 17.0 mass % or less, 16.9 mass % or less, 16.8 mass % or less, 16.7 mass % or less, 16.6 mass % or less, 16.5 mass % or less, 16.4 mass % or less, 16.3 mass % or less, 16.2 mass % or less, 16.1 mass % or less, 16.0 mass % or less, 15.9 mass % or less, 15.8 mass % or less, 15.7 mass % or less, 15.6 mass % or less, 15.5 mass % or less, 15.4 mass % or less, 15.3 mass % or less, 15.2 mass % or less, 15.1 mass % or less, 15.0 mass % or less, 14.9 mass % or less, 14.8 mass % or less, 14.7 mass % or less, 14.6 mass % or less, 14.5 mass % or less, 14.4 mass % or less, 14.3 mass % or less, 14.2 mass % or less, 14.1 mass % or less, 14.0 mass % or less, 13.9 mass % or less, 13.8 mass % or less, 13.7 mass % or less, 13.6 mass % or less, 13.5 mass % or less, 13.4 mass % or less, 13.3 mass % or less, 13.2 mass % or less, 13.1 mass % or less, 13.0 mass % or less, 12.9 mass % or less, 12.8 mass % or less, 12.7 mass % or less, 12.6 mass % or less, 12.5 mass % or less, 12.4 mass % or less, 12.3 mass % or less, 12.2 mass % or less, 12.1 mass % or less, 12.0 mass % or less, 11.9 mass % or less, 11.8 mass % or less, 11.7 mass % or less, 11.6 mass % or less, 11.5 mass % or less, 11.4 mass % or less, 11.3 mass % or less, 11.2 mass % or less, 11.1 mass % or less, 11.0 mass % or less, 10.9 mass % or less, 10.8 mass % or less, 10.7 mass % or less, 10.6 mass % or less, 10.5 mass % or less, 10.4 mass % or less, 10.3 mass % or less, 10.2 mass % or less, 10.1 mass % or less, 10.0 mass % or less, 9.9 mass % or less, 9.8 mass % or less, 9.7 mass % or less, 9.6 mass % or less, 9.5 mass % or less, 9.4 mass % or less, 9.3 mass % or less, 9.2 mass % or less, 9.1 mass % or less, 9.0 mass % or less, 8.9 mass % or less, 8.8 mass % or less, 8.7 mass % or less, 8.6 mass % or less, 8.5 mass % or less, 8.4 mass % or less, 8.3 mass % or less, 8.2 mass % or less, 8.1 mass % or less, 8.0 mass % or less, 7.9 mass % or less, 7.8 mass % or less, 7.7 mass % or less, 7.6 mass % or less, 7.5 mass % or less, 7.4 mass % or less, 7.3 mass % or less, 7.2 mass % or less, 7.1 mass % or less, 7.0 mass % or less, 6.9 mass % or less, 6.8 mass % or less, 6.7 mass % or less, 6.6 mass % or less, 6.5 mass % or less, 6.4 mass % or less, 6.3 mass % or less, 6.2 mass % or less, 6.1 mass % or less, 6.0 mass % or less, 5.9 mass % or less, 5.8 mass % or less, 5.7 mass % or less, 5.6 mass % or less, 5.5 mass % or less, 5.4 mass % or less, 5.3 mass % or less, 5.2 mass % or less, or 5.1 mass % or less.

The “original wort extract concentration” in the present specification can be measured by the method described in “BCOJ Beer Analysis Method (published by The Brewing Society of Japan, edited by Brewers Association of Japan, revised edition of Nov. 1, 2004)”.

The product of the malt proportion (unit: mass %) and the original wort extract concentration (unit: mass %) [malt proportion×original wort extract concentration] of the beer-taste beverage may be 100 or more, 120 or more, 150 or more, 170 or more, 200 or more, 220 or more, 250 or more, 270 or more, 300 or more, 350 or more, 400 or more, 450 or more, 500 or more, 550 or more, 600 or more, 650 or more, 700 or more, 750 or more, 800 or more, 850 or more, 900 or more, 950 or more, 1000 or more, 1100 or more, 1200 or more, 1300 or more, 1400 or more, 1500 or more, 1600 or more, or 1700 or more, and may be 10000 or less, 9500 or less, 9000 or less, 8500 or less, 8000 or less, 7500 or less, 7000 or less, 6500 or less, 6000 or less, 5500 or less, 5000 or less, 4500 or less, 4000 or less, 3500 or less, 3000 or less, 2500 or less, or 2000 or less.

When the beer-taste beverage according to an embodiment of the present invention is a non-alcoholic beer-taste beverage, the apparent extract concentration of the non-alcoholic beer-taste beverage may be 5.0 mass % or less, 4.0 mass % or less, 3.5 mass % or less, 3.0 mass % or less, 2.5 mass % or less, 2.0 mass % or less, 1.8 mass % or less, 1.6 mass % or less, 1.4 mass % or less, 1.2 mass % or less, 1.0 mass % or less, 0.9 mass % or less, 0.8 mass % or less, 0.7 mass % or less, 0.6 mass % or less, 0.5 mass % or less, 0.4 mass % or less, 0.3 mass % or less, or may be 0.2 mass % or less from the viewpoint of making a beverage having a clear taste, and may be 0.05 mass % or more, 0.1 mass % or more, 0.2 mass % or more, 0.3 mass % or more, 0.4 mass % or more, 0.5 mass % or more, 0.6 mass % or more, 0.7 mass % or more, 0.8 mass % or more, 0.9 mass % or more, 1.0 mass % or more, 1.5 mass % or more, 2.0 mass % or more, 2.5 mass % or more, 3.0 mass % or more, or 4.0 mass % or more from the viewpoint of making a beverage having a good taste.

The “apparent extract concentration” in the present specification can be measured by the method described in “8.2 Apparent Extract” in “BCOJ Beer Analysis Method (published by The Brewing Society of Japan, edited by Brewers Association of Japan, revised edition of Nov. 1, 2004)”.

The bitterness value of the beer-taste beverage may be 200 BUs or less, 150 BUs or less, 100 BUs or less, 90.0 BUs or less, 80 BUs or less, 70.0 BUs or less, 60 BUs or less, 55 BUs or less, 50 BUs or less, 45 BUs or less, 40 BUs or less, 39.0 BUs or less, 38.0 BUs or less, 37.0 BUs or less, 36.0 BUs or less, 35 BUs or less, 34.0 BUs or less, 33.0 BUs or less, 32.0 BUs or less, 31.0 BUs or less, 30 BUs or less, 29.0 BUs or less, 28.0 BUs or less, 27.0 BUs or less, 26.0 BUs or less, or 25 BUs or less from the viewpoint of making a beverage typical of a beer-taste beverage.

In a case of a beer-taste beverage made using hops as a raw material, the bitterness value of the beverage may be 1.0 BUs or more, 2.0 BUs or more, 3.0 BUs or more, 4.0 BUs or more, 5 BUs or more, 6.0 BUs or more, 7 BUs or more, 8.0 BUs or more, 9.0 BUs or more, 10 BUs or more, 11.0 BUs or more, 12 BUs or more, 13.0 BUs or more, 14.0 BUs or more, 15 BUs or more, 16.0 BUs or more, 17 BUs or more, 18.0 BUs or more, 19.0 BUs or more, 20.0 BUs or more, 21.0 BUs or more, 22.0 BUs or more, 23.0 BUs or more, 24.0 BUs or more, 25.0 BUs or more, 26.0 BUs or more, 27.0 BUs or more, 28.0 BUs or more, 29.0 BUs or more, 30.0 BUs or more, 40.0 BUs or more, 50.0 BUs or more, 60.0 BUs or more, 70.0 BUs or more, 80.0 BUs or more, 90.0 BUs or more, or 100 BUs or more.

In a case of a beer-taste beverage made without using hops as a raw material, the bitterness value of the beverage may be less than 5.0 BUs, 4.0 BUs or less, 3.0 BUs or less, 2.0 BUs or less, 1.0 BUs or less, 0.5 BUs or less, 0.3 BUs or less, less than 0.1 BUs, or less than 0.01 BUs.

The bitterness value of the beverage is an index of bitterness imparted by hop-derived components containing isohumulone as a main component and can be controlled by appropriately adjusting the usage amount of hops or a hop-derived component, such as a hop extract.

In the present specification, the “bitterness value” of the beverage can be measured by the measurement method described in “8.15 Bitterness Value” in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

The beer-taste beverage may further contain spirits derived from grain as an alcohol component for the purpose of adjusting the alcoholic strength.

Here, the “spirits” means an alcoholic beverage produced by saccharifying grain, such as wheat, barley, rice, buckwheat, or corn, as a raw material using malt or, as necessary, an enzymatic agent, fermenting the saccharified product using yeast, and then distilling the fermented product.

Among these, from the viewpoint of making a beverage with good taste, the beer-taste beverage preferably contains spirits made from a plant belonging to the family Gramineae as a raw material, preferably contains spirits of barley or the like, and more preferably contains barley spirits or wheat spirits.

The color of the beer-taste beverage is not particularly limited; the color may be amber or gold like ordinary beer, black like black beer, or colorless and transparent, or may be colored as desired by adding a colorant or the like. The color of the beer-taste beverage can be determined by the naked eye, but may be defined by the total light transmittance, chromaticity, or the like.

The chromaticity of the beer-taste beverage may be 0.1 EBC or more, more than 1.0 EBC, 1.5 EBC or more, 2.0 EBC or more, 2.5 EBC or more, 3.0 EBC or more, 3.5 EBC or more, 4.0 EBC or more, 4.5 EBC or more, 5.0 EBC or more, 5.5 EBC or more, 6.0 EBC or more, or 6.5 EBC or more, but is preferably 7.0 EBC or more, 7.2 EBC or more, 7.5 EBC or more, 8.0 EBC or more, 8.5 EBC or more, 9.0 EBC or more, 9.5 EBC or more, 10.0 EBC or more, 10.5 EBC or more, 11.0 EBC or more, 11.5 EBC or more, 12.0 EBC or more, 12.5 EBC or more, or 13.0 EBC or more from the viewpoint of making a beverage excellent in taste typical of a beer-taste beverage, and may be 200 EBC or less, 180 EBC or less, 160 EBC or less, 140 EBC or less, 120 EBC or less, 100 EBC or less, 80 EBC or less, 70 EBC or less, 60 EBC or less, 50 EBC or less, 40 EBC or less, 35 EBC or less, 30 EBC or less, 27 EBC or less, 25 EBC or less, 23 EBC or less, 20 EBC or less, 18 EBC or less, 16 EBC or less, or 15 EBC or less.

In the present specification, the “chromaticity” of the beer-taste beverage can be measured by the measurement method described in “8.8 Chromaticity” in Revised BCOJ Beer Analysis Method (published by Public Interest Incorporated Foundation, The Brewing Society of Japan, edited by Analysis Committee, Brewery Convention of Japan, Brewers Association of Japan, Enlarged and Revised Edition of 2013). The “chromaticity” of the beer-taste beverage is specified by the unit of chromaticity (EBC unit) defined by the European Brewery Convention. A beverage with a smaller numerical value has a lighter and brighter color, whereas a beverage with a larger numerical value has a deeper and darker color.

In addition, the chromaticity of the beer-taste beverage according to an embodiment of the present invention can be controlled, for example, by appropriately adjusting the type of malt used, the blending proportion in a case of using two or more types of malts in combination, the boiling conditions for preparation of the pre-fermentation liquid, or like. More specifically, for example, to increase the chromaticity of the beer-taste beverage, the chromaticity can be adjusted by increasing the blending proportion of dark malt as the malt, increasing the temperature during boiling treatment, increasing boiling time, performing decoction during preparation of a saccharified liquid, and the like. Further, the chromaticity of the beer-taste beverage can also be adjusted to a higher level by increasing the original wort extract concentration or increasing the malt proportion.

The pH of the beer-taste beverage is not particularly limited, but from the viewpoint of suppressing the occurrence of microorganisms, the pH may be 5.0 or lower, 4.9 or lower, 4.8 or lower, 4.7 or lower, 4.6 or lower, 4.55 or lower, or 4.5 or lower, and from the viewpoint of improving the flavor of the beer-taste beverage, the pH may be 2.0 or higher, 2.1 or higher, 2.2 or higher, 2.3 or higher, 2.4 or higher, 2.5 or higher, 2.6 or higher, 2.7 or higher, 2.8 or higher, 2.9 or higher, 3.0 or higher, 3.1 or higher, 3.2 or higher, 3.3 or higher, 3.4 or higher, 3.5 or higher, 3.6 or higher, 3.7 or higher, 3.8 or higher, 3.9 or higher, 4.0 or higher, 4.1 or higher, or 4.2 or higher.

### 3 Raw Material for Beer-Taste Beverage

When the packaged beverage according to an embodiment of the present invention is a beer-taste beverage, a raw material commonly used in a beer-taste beverage can be used. For example, water and malt can be used as main raw materials in a case of a beer-taste beverage, but instead of malt or together with malt, grains other than malt may be used. Further, the beer-taste beverage may be a beverage made using hops as a raw material or may be a beverage made without using hops.

3.1 Malt and Grain Other than Malt

When the packaged beverage according to an embodiment of the present invention is a beer-taste beverage, the malt to be used as the raw material refers to malt obtained by germinating seeds of barley or the like, such as barley, wheat, rye, wild oats, oats, or adlay, drying the germinated seeds, and removing roots, and may be from any production area and of any variety.

The malt used in an embodiment of the present invention is preferably barley malt. Barley malt is one of the malts most commonly used as a raw material for Japanese beer-taste beverages. Examples of barley include two-rowed barley and six-rowed barley, and any of them may be used. Further, in addition to ordinary malt, colored malt or the like can also be used. When colored malt is used, different types of colored malts may be appropriately used in combination, or one colored malt may be used.

Note that in the beer-taste beverage according to an embodiment of the present invention, the malt to be used is preferably selected as appropriate in accordance with the desired chromaticity of the beer-taste beverage, and the malt to be selected may be used alone or in combination of two or more kinds thereof.

In addition to or instead of malt, a grain other than malt may be used.

Examples of such a grain include barley and the like that do not fall under malt (such as barley, wheat, rye, wild oats, oats, and adlay), rice (such as white rice and brown rice), corn, kaoliang, potato, legumes (such as soybeans and peas), buckwheat, sorghum, foxtail millet, Japanese millet, starch resulting therefrom, and extracts thereof.

Note that in a case of suppressing the malt proportion or not using malt, it is preferable to increase amounts of raw materials (carbon source and nitrogen source) other than malt, which can be utilized by yeast. Examples of the carbon source include liquid sugars, monosaccharides, disaccharides, trisaccharides, and sugar solutions thereof. Examples of the nitrogen source include yeast extract, proteins derived from animals and plants, amino acid-containing raw materials (such as soybean protein) such as the above-described grains other than malt, soybean, yeast extract, pea, wheat malt, ungerminated grains, and decomposition products thereof. Although wheat malt may be used here, it is preferable not to use wheat malt from the viewpoint of allergen.

Note that the beer-taste beverage according to an embodiment of the present invention may be a beverage containing substantially no soybean peptide having a weight average molecular weight less than 10000 as a raw material, or may be a beverage containing no soybean peptide described above.

The “beverage containing substantially no soybean peptide” means a beverage in which the soybean peptide is used in an amount less than 5.0 mass %, less than 3.0 mass %, less than 2.0 mass %, less than 1.0 mass %, less than 0.10 mass %, less than 0.01 mass %, less than 0.001 mass %, or less than 0.0001 mass %, with respect to the total amount (100 mass %) of raw materials excluding water of the beverage.

The fruit, pericarp, bark, leaf, flower, stem, root, and seed of a plant other than plants of the Gramineae family such as barley, which can be used as a raw material, can be appropriately selected.

Specific examples of the plant other than plants of the Gramineae family include citrus fruits, soft fruits, herbs, and spices. Examples of the citrus fruits include an orange, Citrus junos, a lemon, a lime, a mandarin orange, a grapefruit, Citrus Iyo Group, Citrus japonica, Citrus sphaerocarpa, Citrus limetta ‘Daidai’, Citrus depressa, and Citrus sudachi.

Examples of the soft fruits include a peach, a grape, a banana, an apple, a grape, a pineapple, a strawberry, a pear, a muscat, and a blackcurrant. Examples of the herbs and the spices include coriander, pepper, fennel, Sichuan pepper, zanthoxyli fructus, cardamom, caraway, nutmeg, mace, juniper berry, allspice, vanilla, elderberry, grains of paradise, anise, and star anise.

These may be used as they are, may be used after being crushed, may be used in the form of an extract derived by extraction with an extraction solvent such as water or ethanol, or may be used after being squeezed (fruit juice or the like). One of these herbs and spices may be used alone, or two or more thereof may be used in combination.

The above can be used as appropriate in accordance with the gusto of consumers, but in order to enjoy a clear and refreshing taste like beer, it is preferable that the above citrus fruits, soft fruits, herbs, and spices be not used at all or used in a minimum amount as raw materials. In particular, a blackcurrant gives an inappropriate milky aroma in beer, and thus a blackcurrant or blackcurrant juice is preferably not used at all or used in a minimum amount in the raw material.

### 3.2 Hops

When the packaged beverage according to an embodiment of the present invention is a beer-taste beverage, examples of the form of the hops include pellet hops, powdered hops, and hop extract. The hops used may be a processed hop product, such as isomerized hops or reduced hops.

When the packaged beverage according to an embodiment of the present invention is a beer-taste beverage, the amount of hops to be added is appropriately adjusted but is preferably from 0.0001 to 1 mass % based on the total amount (100 mass %) of the raw materials for the beverage.

A beer-taste beverage made using hops as a raw material is a beverage containing iso-α-acid, which is a component derived from hops. The content of iso-α-acid in the beer-taste beverage made using hops may be greater than 0.1 mass ppm or greater than 1.0 mass ppm based on the total amount (100 mass %) of the beer-taste beverage.

On the other hand, the content of iso-α-acid in a beer-taste beverage made without using hops may be 0.1 mass ppm or less based on the total amount (100 mass %) of the beer-taste beverage.

In the present specification, the content of iso-α-acid means a value measured by the high-performance liquid chromatography (HPLC) analysis method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

### 4 Various Additives Contained in Packaged Beverage

When the packaged beverage containing a beer-taste beverage according to an embodiment of the present invention is a beverage, a preservative, a sweetener, a water-soluble dietary fiber, a bittering agent or a bitterness-imparting agent, an antioxidant, a flavoring, an acidulant, a salt, or the like may be used according to the type of each beverage.

### 4.1 Preservative

The packaged beverage according to an embodiment of the present invention may be a beverage in which a preservative is further blended, or may be a beverage in which no preservative is blended (added).

Examples of the preservative used in an embodiment of the present invention include benzoic acid; benzoate salts, such as sodium benzoate; benzoate esters, such as propyl parahydroxybenzoate and butyl parahydroxybenzoate; and dimethyl dicarbonate. For the preservative, a commercially available preparation, such as Strong SANPRESER (a mixture of sodium benzoate and butyl benzoate, available from San-Ei Gen F.F.I., Inc.) may be used.

One of these preservatives may be used alone, or two or more of these preservatives may be used in combination.

The amount of the preservative to be blended in the packaged beverage according to an embodiment of the present invention is preferably from 5 to 1200 mass ppm, more preferably from 10 to 1100 mass ppm, even more preferably from 15 to 1000 mass ppm, and still even more preferably from 20 to 900 mass ppm based on the total amount (100 mass %) of the beverage.

### 4.2 Sweetener

The packaged beverage according to an embodiment of the present invention may be a beverage in which a sweetener is further blended, or may be a beverage in which no sweetener is blended (added).

Examples of the sweetener used in an embodiment of the present invention include saccharified liquid in which starch derived from grain has been degraded with an acid, an enzyme, or the like; saccharides such as commercially available starch syrup; sucrose; tri-or higher saccharides; isomerized sugar; sugar alcohols; natural sweeteners, such as stevia; and artificial sweeteners.

One of these sweeteners may be used alone, or two or more of these sweeteners may be used in combination.

These saccharides may be in the form of a liquid, such as a solution, or a solid, such as a powder.

There are no particular limitations on the type of raw material grain for starch, the method of purifying starch, and the conditions for treatment, such as hydrolysis with an enzyme or an acid. For example, a saccharide may be used with the proportion of maltose increased by appropriately setting conditions for hydrolysis with an enzyme or an acid. In addition, sucrose, fructose, glucose, maltose, trehalose, maltotriose, maltotetraose, panose, lactose, galactose, isomaltose, isomaltotriose, isomaltotetraose, and solutions thereof (sugar solutions) can also be used.

Examples of the artificial sweetener include aspartame, acesulfame potassium (acesulfame K), sucralose, and neotame.

### 4.3 Water-Soluble Dietary Fiber

The packaged beverage according to an embodiment of the present invention may be a beverage in which a water-soluble dietary fiber is blended, or may be a beverage in which no water-soluble dietary fiber is blended (added).

Examples of the water-soluble dietary fiber include indigestible dextrin, polydextrose, guar gum degradation products, pectin, glucomannan, alginic acid, laminarin, fucoidin, and carrageenan. From the viewpoint of versatility, such as stability and safety, indigestible dextrin or polydextrose is preferred.

Note that the packaged beverage according to an embodiment of the present invention may be a beverage in which no indigestible dextrin is blended (added) as a raw material. The packaged beverage of this embodiment contains a water-soluble dietary fiber derived from raw materials (for example, malt and the like) without blending (adding) indigestible dextrin. The content of water-soluble dietary fiber derived from raw materials is described in, for example, Standard Tables of Food Composition in Japan 2020 (eighth revised edition).

In the packaged beverage according to an embodiment of the present invention, the content of the water-soluble dietary fiber may be, based on the total amount (100 mass %) of the packaged beverage, 0.05 mass % or more, 0.1 mass % or more, 0.15 mass % or more, 0.2 mass % or more, 0.25 mass % or more, 0.3 mass % or more, 0.35 mass % or more, 0.4 mass % or more, 0.5 mass % or more, 0.7 mass % or more, 1.0 mass % or more, 1.5 mass % or more, 2.0 mass % or more, 2.5 mass % or more, or 3.0 mass % or more, and may be 5.0 mass % or less, 4.5 mass % or less, 4.0 mass % or less, 3.5 mass % or less, 3.0 mass % or less, 2.5 mass % or less, 2.0 mass % or less, less than 1.5 mass %, less than 1.0 mass %, less than 0.75 mass %, less than 0.60 mass %, less than 0.50 mass %, 0.40 mass % or less, 0.35 mass % or less, 0.30 mass % or less, 0.25 mass % or less, 0.20 mass % or less, 0.15 mass % or less, 0.10 mass % or less, or less than 0.10 mass %.

The content of the water-soluble dietary fiber may be adjusted to fall within the above range by adding a commercially available product, or may be adjusted in the production process in such a manner that the content of the dietary fiber derived from a raw material such as malt falls within the above range. In a case of adding a commercially available product, when the content of the water-soluble dietary fiber is within the above-described range, powderiness unsuitable for a beverage can be suppressed. In a case of adjusting the content of the dietary fiber in the production process, the content of the water-soluble dietary fiber is set within the above range, and thus, for example, the filterability in wort filtration or beer filtration can be improved to increase the production efficiency, when the beverage is a beer-taste beverage.

In a case of adjusting the content of water-soluble dietary fiber in the production process, the content of water-soluble dietary fiber in the packaged beverage according to an embodiment of the present invention can be adjusted by adjusting the addition of dilution water or carbonated water, the type of raw materials (such as barley, malt, corn, and sugar solution), the amount of raw material, the type of enzyme, the amount of enzyme added, the timing of enzyme addition (such as during the saccharification step, before addition of yeast, after addition of yeast, and during aging), the set temperature, pH, and holding time in each temperature region in preparing the saccharified liquid, and the like.

### 4.4 Bittering Agent and Bitterness-Imparting Agent

The packaged beverage according to an embodiment of the present invention may be a beverage in which one or more selected from a bittering agent and a bitterness-imparting agent is/are blended, or may be a beverage in which a bittering agent and/or a bitterness-imparting agent are/is not blended (added).

In particular, when the packaged beverage according to an embodiment of the present invention is a beer-taste beverage, bitterness may be imparted by hops, or a bittering agent or bitterness-imparting agent indicated below may be used together with hops. Alternatively, the bittering agent or bitterness-imparting agent indicated below may be used instead of hops without using hops.

The bittering agent or bitterness-imparting agent is not particularly limited, and a substance used as a bitterness-imparting agent in ordinary beer and low-malt beer can be used. Examples thereof include rosemary, litchi, caraway, juniper berry, sage, Ganoderma sichuanense, bay laurel, quassin, caffeine, absinthin, naringin, Phellodendron amurense, citrus extract, bitter wood extract, coffee extract, tea extract, bitter gourd extract, lotus embryo extract, Aloe arborescens extract, rosemary extract, litchi extract, laurel extract, sage extract, caraway extract, Artemisia absinthium, absinthin, and alginic acid.

One of these bittering agents and bitterness-imparting agents may be used alone, or two or more thereof may be used in combination.

### 4.5 Flavoring

The packaged beverage according to an embodiment of the present invention may be a beverage in which a flavoring is further blended, or may be a beverage in which no flavoring is blended (added).

The flavoring is not particularly limited and can be appropriately selected according to each beverage.

For example, when the packaged beverage according to an embodiment of the present invention is a beer-taste beverage, examples of the beer flavoring include esters and higher alcohols, and specific examples include n-propanol and isobutanol. One of these flavorings may be used alone, or two or more of these flavorings may be used in combination.

### 4.6 Acidulant

The packaged beverage according to an embodiment of the present invention may be a beverage in which an acidulant is further blended, or may be a beverage in which no acidulant is blended (added).

The acidulant is not particularly limited as long as it is a substance with a sour taste, and examples include tartaric acid, phosphoric acid, citric acid, gluconic acid, lactic acid, malic acid, phytic acid, acetic acid, succinic acid, glucono-delta-lactone, and salts thereof.

Among these, the acidulant is preferably at least one selected from tartaric acid, phosphoric acid, citric acid, gluconic acid, lactic acid, malic acid, phytic acid, acetic acid, succinic acid, and salts thereof, more preferably at least one selected from tartaric acid, phosphoric acid, citric acid, lactic acid, tartaric acid, acetic acid, and salts thereof, and even more preferably at least one selected from tartaric acid, phosphoric acid, and lactic acid.

One of these acidulants may be used alone, or two or more of these acidulants may be used in combination.

### 4.7 Salt

The packaged beverage according to an embodiment of the present invention may be a beverage in which salt is further blended, or may be a beverage in which no salt is blended (added).

Examples of the salt include sodium chloride, acid potassium phosphate, acid calcium phosphate, ammonium phosphate, magnesium sulfate, calcium sulfate, potassium metabisulfite, calcium chloride, magnesium chloride, potassium nitrate, and ammonium sulfate.

One of these salts may be used alone, or two or more of these salts may be used in combination.

### 4.8 Carbon Dioxide Gas

When the packaged beverage according to an embodiment of the present invention is a carbonated beverage, it contains carbon dioxide gas.

The amount of carbon dioxide gas in the carbonated beverage may be adjusted using carbonation equipment or may be adjusted by adding carbonated water.

When the packaged beverage according to an embodiment of the present invention is a fermented beverage, carbon dioxide gas produced in the fermentation step can be used as it is as carbon dioxide gas contained in the beer-taste beverage.

The carbon dioxide gas concentration in the case where the packaged beverage according to an embodiment of the present invention is a carbonated beverage is preferably 0.30 (w/w) % or more, more preferably 0.35 (w/w) % or more, even more preferably 0.40 (w/w) % or more, still more preferably 0.42 (w/w) % or more, and particularly preferably 0.45 (w/w) % or more, and preferably 0.80 (w/w) % or less, more preferably 0.70 (w/w) % or less, even more preferably 0.60 (w/w) % or less, still more preferably 0.57 (w/w) % or less, and particularly preferably 0.55 (w/w) % or less.

In the present specification, the carbon dioxide gas concentration can be measured by immersing a container containing a target carbonated beverage in a water bath at 20° C. for 30 minutes or more with occasional shaking of the container to adjust the beverage to 20° C. and then using a gas volume measuring instrument (e.g., such as GVA-500 (available from Kyoto Electronics Manufacturing Co., Ltd.)).

### 4.9 Additional Additive

In the packaged beverage according to an embodiment of the present invention, various additives may be added as necessary to the extent that the effects of the present invention are not hindered.

Examples of such an additive include colorants; foam-forming agents; fermentation promoters; yeast extract; protein-based substances, such as peptide-containing substances; and seasonings, such as amino acids.

The colorant is used to impart a desired color to the packaged beverage, and a caramel dye, a cacao dye, a safflower dye, a colored sugar solution, and/or the like can be used.

When the packaged beverage according to an embodiment of the present invention is a beer-taste beverage, the foam-forming agent is used to form beer-like foam or to keep the foam of the beverage, and a plant-extracted saponin-based substance, such as soybean saponin and/or quillaja saponin; a plant protein, such as corn and/or soybean; a peptide-containing substance, such as a collagen peptide; a yeast extract; an emulsifier (sucrose fatty acid ester, glycerin fatty acid ester, lecithin, and/or lysolecithin); β-glucan, β-glucan processed product, cellulose, cellulose processed product, and/or the like can be appropriately used.

The fermentation promoter is used to promote fermentation by yeast in the case where the packaged beverage according to an embodiment of the present invention is a fermented beverage. For example, a yeast extract; a bran component, such as rice or wheat bran; a vitamin; a mineral agent; and/or the like can be used alone or in combination.

### 5. Method for Producing Packaged Beverage

A method for producing a packaged beverage, according to an embodiment of the present invention, includes a step (A) of adjusting an oxidation-reduction potential of a beverage to 5.00 mV or less using a hydrogen generating material.

The type of hydrogen generating material used in the step (A) and the range of the oxidation-reduction potential are as described above.

In an embodiment of the present invention, the step (A) can be carried out by incorporating an additive containing the hydrogen generating material into the beverage or the container. That is, the additive may be added to the beverage previously filled in the container, or the additive may be charged into the container and then the beverage may be filled therein.

The additive containing the hydrogen generating material used in an embodiment of the present invention is as described above.

By bringing the additive containing the hydrogen generating material into contact with the beverage filled in the container, and hydrogen is generated, whereby a packaged beverage having an oxidation-reduction potential of 5.00 mV or less can be produced.

In an embodiment of the present invention, the step (A) can be carried out by filling the beverage into a beverage filling container (I) having a layer containing the hydrogen generating material or a beverage filling container (II) in which a member containing the hydrogen generating material is present.

Specific configurations of the beverage filling containers (I) and (II) are as described above.

By filling a beverage into the beverage filling container (I) or (II), the beverage and the hydrogen generating material are brought into contact with each other to generate hydrogen, thereby making it possible to produce a packaged beverage having an oxidation-reduction potential of 5.00 mV or less.

### 6. Method for Suppressing Deterioration of Packaged Beverage

The present invention can also provide a method for suppressing deterioration of a packaged beverage, including adjusting an oxidation-reduction potential of a beverage to 5.00 mV or less using a hydrogen generating material.

By adjusting the oxidation-reduction potential of the packaged beverage to 5.00 mV or less, a decrease in flavor of the packaged beverage can be suppressed, and deterioration of the packaged beverage can be suppressed.

The range of the oxidation-reduction potential to be adjusted is as described above.

In an embodiment of the present invention, examples of the operation for decreasing the oxidation-reduction potential of a beverage containing a hydrogen generating material includes an operation of incorporating an additive containing the hydrogen generating material into the beverage or the container. In the operation, the additive may be added to the beverage previously filled in the container, or the additive may be charged into the container and then the beverage may be filled therein.

In an embodiment of the present invention, examples of the operation for decreasing the oxidation-reduction potential of a beverage containing a hydrogen generating material include an operation of filling the beverage into the beverage filling container (I) having a layer containing the hydrogen generating material or the beverage filling container (II) having a member containing the hydrogen generating material.

Specific configurations of the beverage filling containers (I) and (II) are as described above.

### EXAMPLES

Hereinafter, the present invention will be described in more detail by examples, but the present invention is not limited by these examples.

The oxidation-reduction potential of each beverage was measured using a product under the name “ORP Meter HM-40P” (available from DKK-TOA CORPORATION) after the packaged beverage at 20° C. was opened and transferred to a beaker.

The packaged beverages produced in Examples and Comparative Examples were subjected to sensory evaluation by the following method.

### Sensory Evaluation

Five panelists who had been regularly trained evaluated the packaged beverages produced in Examples and Comparative Examples cooled to approximately 4° C. by a score in a range of 5.0 (maximum value) to 1.0 (minimum value) in increments of 0.1 based on the score criteria described below, and average values of the scores of the five panelists were calculated.

In the evaluation, samples that meet the following criteria: reference “5.0”, “4.0”, “3.0”, “2.0”, and “1.0” were prepared in advance to standardize the criteria among the panelists. The packaged beverages immediately after production, which are filled with beverages A to F prepared in Production Examples 1 to 6, are used as samples of the reference “5.0”. In addition, in the sensory evaluation shown in all of Tables 1 to 6, for the same beverage, no difference in a score value of 1.5 or higher was observed among the panelists.

### Score Criteria of Effect of Suppressing Decrease in Flavor

“5.0”: The beverage has a good flavor similar to that of the packaged beverage immediately after production, and a very excellent flavor is maintained.
“4.0”: A slight decrease in flavor is perceived as compared with that in the packaged beverage immediately after production, but a good flavor is maintained.
“2.0”: A little decrease in flavor is perceived as compared with that in the packaged beverage immediately after production, but the flavor is maintained to some extent.
“1.5”: A decrease in flavor is clearly perceived as compared with that in the packaged beverage immediately after production, and a deterioration odor is also perceived.
“1.0”: A decrease in flavor is very clearly perceived as compared with that in the packaged beverage immediately after production, and a strong deterioration odor is also perceived.

### Production Example 1 (Preparation of Beverage A)

The ground barley malt was charged into a preparation tank containing 40 L of warm water kept at 52° C., and the solution was kept for 30 minutes, then kept at 65° C. for 40 minutes, and further kept at 76° C. for 5 minutes while the temperature was raised stepwise to prepare a saccharified liquid. Then, the saccharified liquid was filtered to remove malt lees, thereby obtaining wort. Hops were added to the resulting wort, followed by boiling. The wort after boiling was subjected to a solid-liquid separation treatment, the resulting clear wort was cooled, and yeasts were added to adjust the fermentation temperature and fermentation time to perform alcohol fermentation, thereby preparing a fermentation liquid. Thereafter, the yeasts and the like were removed by filtration to prepare a beer-taste beverage A having a malt proportion of 100 mass %, a real extract concentration of 4.2 mass %, and a sugar content of 3.6 g/100 mL (beer according to the Liquor Tax Law, hereinafter also referred to as “beverage A”). The beverage A is a beverage substantially free of antioxidant.

### Production Example 2 (Preparation of Beverage B)

The ground barley malt and a polysaccharidase were charged into a preparation tank containing 40 L of warm water kept at 52° C., and the solution was kept for 30 minutes, then kept at 65° C. for 40 minutes, and further kept at 76° C. for 5 minutes while the temperature was raised stepwise to prepare a saccharified liquid. Then, the saccharified liquid was filtered to remove malt lees, thereby obtaining wort. A sugar solution and hops were added to the resulting wort, followed by boiling. The wort after boiling was subjected to a solid-liquid separation treatment, the resulting clear wort was cooled, and yeasts and a polysaccharidase that can convert sugars which cannot be assimilated by the yeasts into assimilable sugars were added to adjust the fermentation temperature and fermentation time to perform alcohol fermentation, thereby preparing a fermentation liquid. Thereafter, the yeasts and the like were removed by filtration, and a heat treatment was performed to prepare a beer-taste beverage B having a malt proportion of 64 mass %, a real extract concentration of 0.80 mass %, and a sugar content of 0.40 g/100 mL (beer according to the Liquor Tax Law, hereinafter also referred to as “beverage B”). The beverage B is a beverage substantially free of antioxidant.

### Production Example 3 (Preparation of Beverage C)

The ground barley malt was charged into a preparation tank containing 40 L of warm water kept at 52° C., and the solution was kept for 30 minutes, then kept at 65° C. for 40 minutes, and further kept at 76° C. for 5 minutes while the temperature was raised stepwise to prepare a saccharified liquid. Then, the saccharified liquid was filtered to remove malt lees, thereby obtaining wort. A sugar solution and hops were added to the resulting wort, followed by boiling. The wort after boiling was subjected to a solid-liquid separation treatment, the resulting clear wort was cooled, yeasts were added to adjust the fermentation temperature and fermentation time to perform alcohol fermentation, thereby preparing a fermentation liquid. Thereafter, the yeasts and the like were removed by filtration to obtain a fermentation liquid. Spirits was added to the fermentation liquid to prepare a fermented beer-taste beverage C having a malt proportion of 49 mass %, a real extract concentration of 3.40 mass %, and a sugar content of 3.2 g/100 mL (liqueur according to the Liquor Tax Law, hereinafter also referred to as “beverage C”). The beverage C is a beverage substantially free of antioxidant.

### Production Example 4 (Preparation of Beverage D)

The ground barley malt was charged into a preparation tank containing 40 L of warm water kept at 52° C., and the solution was kept for 30 minutes, then kept at 65° C. for 40 minutes, and further kept at 76° C. for 5 minutes while the temperature was raised stepwise to prepare a saccharified liquid. Then, the saccharified liquid was filtered to remove malt lees, thereby obtaining wort. A sugar solution, water-soluble dietary fibers and hops were added to the resulting wort, followed by boiling. The wort after boiling was subjected to a solid-liquid separation treatment, the resulting clear wort was cooled, yeasts were added to adjust the fermentation temperature and fermentation time to perform alcohol fermentation, thereby preparing a fermentation liquid. Thereafter, the yeasts and the like were removed by filtration to obtain a fermentation liquid. Spirits was added to the fermentation liquid to prepare a fermented beer-taste beverage D having a malt proportion of 38 mass %, a real extract concentration of 2.40 mass %, and a sugar content of 0.65 g/100 mL (liqueur according to the Liquor Tax Law, hereinafter also referred to as “beverage D”). The beverage D is a beverage substantially free of antioxidant.

### Production Example 5 (Preparation of Beverage E)

A corn protein decomposition product, a yeast extract, and a caramel dye were dissolved in warm water at 50° C., and liquid sugars, water-soluble dietary fibers, and hops were added to the resulting solution, followed by boiling. The wort after boiling was subjected to a solid-liquid separation treatment, the resulting clear wort was cooled, yeasts were added to adjust the fermentation temperature and fermentation time to perform alcohol fermentation, thereby preparing a fermentation liquid. Thereafter, a brewed alcohol was added. A beer flavoring, an acidulant, and acesulfame K were added, and yeasts and the like were removed by filtration to prepare a fermented beer-taste beverage E (other brewed alcoholic beverages according to the Liquor Tax Law, hereinafter also referred to as “beverage E”) having a malt proportion of 0 mass %, a real extract concentration of 2.2 mass %, and a sugar content of 1.5 g/100 mL. The beverage E is a beverage substantially free of antioxidant.

### Production Example 6 (Preparation of Beverage F)

The ground barley malt was charged into a preparation tank containing 40 L of warm water kept at 52° C., and the solution was kept for 30 minutes, then kept at 65° C. for 40 minutes, and further kept at 76° C. for 5 minutes while the temperature was raised stepwise to prepare a saccharified liquid. Then, the saccharified liquid was filtered to remove malt lees, thereby obtaining wort. Hops were added to the resulting wort, followed by boiling. Then, acidulants (lactic acid and phosphoric acid) were added, solid-liquid separation was performed, and the resulting clear wort was cooled. Then, a caramel dye, an acidulant (lactic acid), a beer flavoring, and carbon dioxide gas were added to the cooled wort, and the mixture was subjected to a filtration treatment and a heat treatment to prepare a non-fermented non-alcoholic beer-taste beverage F having a real extract concentration of 0.36 mass %, an apparent extract concentration of 0.36 mass %, a sugar content of less than 0.50 g/100 mL, and an alcoholic strength of 0.0050 (v/v) % (carbonated beverage as defined in the Japanese Agricultural Standards (Ministry of Agriculture, Forestry and Fisheries Notification No. 1572 Oct. 20, 2017), hereinafter also referred to as “beverage F”). The beverage F is a beverage substantially free of antioxidant.

### Examples A-1 to A-3 and Comparative Examples A-1 to A-2

The beverage A prepared in Production Example 1 was filled in an aluminum can, the following operation was performed, and then the can was filled with carbon dioxide gas so that the gas pressure of the packaged beverage was 2.2 kg/cm², and sealed to produce four packaged beverage samples each.
Examples A-1 to A-3: Magnesium hydride (MgH₂) as a hydrogen generating material was added at a concentration shown in Table 1.
Comparative Example A-1: No operation was performed.
Comparative Example A-2: The beverage was subjected to an electrolysis treatment using a hydrogen water generator GAURA mini (available from GAURA) without adding anything.

The amount of dissolved oxygen in the beverages of Examples A-1 to A-3 and the beverage of Comparative Example A-1 was 0.5 mg/L or less.

Among the four packaged beverage samples, the temperature of one sample was adjusted to 20° C., the oxidation-reduction potential of the beverage immediately after production was measured based on the measurement method described above, the temperature of another sample was adjusted to around 4° C., and the sensory evaluation described above was performed. In addition, the remaining two samples were left to stand for one week in an environment of 37° C. to deteriorate, then the temperature of one sample was adjusted to 20° C., the oxidation-reduction potential of the beverage after standing was measured based on the measurement method described above, and the temperature of another sample was adjusted to around 4° C., and the sensory evaluation described above. The results are shown in Table 1.

TABLE 1

| | Comparative | Comparative | | | |
|---|---|---|---|---|---|
| | Example A-1 | Example A-2 | Example A-1 | Example A-2 | Example A-3 |
| Method for adjusting oxidation- | None | Electrolysis | Addition of | Addition of | Addition of |
| reduction potential | | | MgH₂ | MgH₂ | MgH₂ |
| Amount (g/L) of hydrogen | — | — | 0.4 | 0.8 | 1.2 |
| generating material added | | | | | |
| Oxidation-reduction potential | 14.5 | −149 | −129 | −240 | −430 |
| (mV) of beverage immediately | | | | | |
| after production | | | | | |
| Oxidation-reduction potential | 172 | −111 | −101 | −205 | −402 |
| (mV) of beverage after standing | | | | | |
| Flavor evaluation of beverage | 5.0 (reference) | 1.6 | 4.6 | 4.5 | 4.4 |
| immediately after production | | | | | |
| Flavor evaluation of beverage | 3.0 | 1.4 | 3.7 | 3.9 | 4.0 |
| after standing | | | | | |

From Table 1, it was confirmed that the beverages of Examples A-1 to A-3 had excellent results in the flavor evaluation of the beverage after standing at 37° C. for one week as compared with the beverage of Comparative Example A-1, and had the effect of suppressing a decrease in deterioration. In the beverage of Comparative Example A-2, a decrease in flavor of the beverage was already observed at the stage immediately after production due to the electrolysis treatment.

### Examples B-1 to B-3 and Comparative Example B-1

The beverage B prepared in Production Example 2 was filled in an aluminum can. In Examples B-1 to B-3, magnesium hydride (MgH₂) as a hydrogen generating material was added at a concentration shown in Table 2, and, in Comparative Example B-1, the can was filled with carbon dioxide gas so that the gas pressure of the packaged beverage was 2.2 kg/cm², and sealed, without any operation, thereby producing four packaged beverage samples each.

The amount of dissolved oxygen in the beverages of Examples B-1 to B-3 and the beverage of Comparative Example B-1 was 0.5 mg/L or less.

Among the four packaged beverage samples, the temperature of one sample was adjusted to 20° C., the oxidation-reduction potential of the beverage immediately after production was measured based on the measurement method described above, the temperature of another sample was adjusted to around 4° C., and the sensory evaluation described above was performed. In addition, the remaining two samples were left to stand for one week in an environment of 37° C. to deteriorate, then the temperature of one sample was adjusted to 20° C., the oxidation-reduction potential of the beverage after standing was measured based on the measurement method described above, and the temperature of another sample was adjusted to around 4° C., and the sensory evaluation described above. The results are shown in Table 2.

TABLE 2

| | Comparative | | | |
|---|---|---|---|---|
| | Example B-1 | Example B-1 | Example B-2 | Example B-3 |
| Method for adjusting oxidation- | None | Addition of | Addition of | Addition of |
| reduction potential | | MgH₂ | MgH₂ | MgH₂ |
| Amount (g/L) of hydrogen | — | 0.4 | 0.8 | 1.2 |
| generating material added | | | | |
| Oxidation-reduction potential | 25 | −89.5 | −200.5 | −390.5 |
| (mV) of beverage immediately | | | | |
| after production | | | | |
| Oxidation-reduction potential | 182.5 | −61.5 | −165.5 | −362.5 |
| (mV) of beverage after standing | | | | |
| Flavor evaluation of beverage | 5.0 (reference) | 4.5 | 4.4 | 4.3 |
| immediately after production | | | | |
| Flavor evaluation of beverage | 2.9 | 3.5 | 3.8 | 4.0 |
| after standing | | | | |

From Table 2, it was confirmed that the beverages of Examples B-1 to B-3 had excellent results in the flavor evaluation of the beverage after standing at 37° C. for one week as compared with the beverage of Comparative Example B-1, and had the effect of suppressing a decrease in deterioration.

### Examples C-1 to C-3 and Comparative Example C-1

The beverage C prepared in Production Example 3 was filled in an aluminum can. In Examples C-1 to C-3, magnesium hydride (MgH₂) as a hydrogen generating material was added at a concentration shown in Table 3, and, in Comparative Example C-1, the can was filled with carbon dioxide gas so that the gas pressure of the packaged beverage was 2.2 kg/cm², and sealed, without any operation, thereby producing four packaged beverage samples each.

The amount of dissolved oxygen in the beverages of Examples C-1 to C-3 and the beverage of Comparative Example C-1 was 0.5 mg/L or less.

Among the four packaged beverage samples, the temperature of one sample was adjusted to 20° C., the oxidation-reduction potential of the beverage immediately after production was measured based on the measurement method described above, the temperature of another sample was adjusted to around 4° C., and the sensory evaluation described above was performed. In addition, the remaining two samples were left to stand for one week in an environment of 37° C. to deteriorate, then the temperature of one sample was adjusted to 20° C., the oxidation-reduction potential of the beverage after standing was measured based on the measurement method described above, and the temperature of another sample was adjusted to around 4° C., and the sensory evaluation described above. The results are shown in Table 3.

TABLE 3

| | Comparative | | | |
|---|---|---|---|---|
| | Example C-1 | Example C-1 | Example C-2 | Example C-3 |
| Method for adjusting oxidation- | None | Addition of | Addition of | Addition of |
| reduction potential | | MgH₂ | MgH₂ | MgH₂ |
| Amount (g/L) of hydrogen | — | 0.4 | 0.8 | 1.2 |
| generating material added | | | | |
| Oxidation-reduction potential | 40 | −74.5 | −185.5 | −375.5 |
| (mV) of beverage immediately | | | | |
| after production | | | | |
| Oxidation-reduction potential | 197.5 | −46.5 | −150.5 | −347.5 |
| (mV) of beverage after standing | | | | |
| Flavor evaluation of beverage | 5.0 (reference) | 4.6 | 4.5 | 4.2 |
| immediately after production | | | | |
| Flavor evaluation of beverage | 2.8 | 3.3 | 3.7 | 4.0 |
| after standing | | | | |

From Table 3, it was confirmed that the beverages of Examples C-1 to C-3 had excellent results in the flavor evaluation of the beverage after standing at 37° C. for one week as compared with the beverage of Comparative Example C-1, and had the effect of suppressing a decrease in deterioration.

### Examples D-1 to D-3 and Comparative Example D-1

The beverage D prepared in Production Example 4 was filled in an aluminum can. In Examples D-1 to D-3, magnesium hydride (MgH₂) as a hydrogen generating material was added at a concentration shown in Table 4, and, in Comparative Example D-1, the can was filled with carbon dioxide gas so that the gas pressure of the packaged beverage was 2.2 kg/cm², and sealed, without any operation, thereby producing four packaged beverage samples each.

The amount of dissolved oxygen in the beverages of Examples D-1 to D-3 and the beverage of Comparative Example D-1 was 0.5 mg/L or less.

Among the four packaged beverage samples, the temperature of one sample was adjusted to 20° C., the oxidation-reduction potential of the beverage immediately after production was measured based on the measurement method described above, the temperature of another sample was adjusted to around 4° C., and the sensory evaluation described above was performed. In addition, the remaining two samples were left to stand for one week in an environment of 37° C. to deteriorate, then the temperature of one sample was adjusted to 20° C., the oxidation-reduction potential of the beverage after standing was measured based on the measurement method described above, and the temperature of another sample was adjusted to around 4° C., and the sensory evaluation described above. The results are shown in Table 4.

TABLE 4

| | Comparative | | | |
|---|---|---|---|---|
| | Example D-1 | Example D-1 | Example D-2 | Example D-3 |
| Method for adjusting oxidation- | None | Addition of | Addition of | Addition of |
| reduction potential | | MgH₂ | MgH₂ | MgH₂ |
| Amount (g/L) of hydrogen | — | 0.4 | 0.8 | 1.2 |
| generating material added | | | | |
| Oxidation-reduction potential | 49 | −65.5 | −176.5 | −366.5 |
| (mV) of beverage immediately | | | | |
| after production | | | | |
| Oxidation-reduction potential | 206.5 | −37.5 | −141.5 | −338.5 |
| (mV) of beverage after standing | | | | |
| Flavor evaluation of beverage | 5.0 (reference) | 4.6 | 4.4 | 4.3 |
| immediately after production | | | | |
| Flavor evaluation of beverage | 2.8 | 3.4 | 3.7 | 4.0 |
| after standing | | | | |

From Table 4, it was confirmed that the beverages of Examples D-1 to D-3 had excellent results in the flavor evaluation of the beverage after standing at 37° C. for one week as compared with the beverage of Comparative Example D-1, and had the effect of suppressing a decrease in deterioration.

### Examples E-1 to E-3 and Comparative Example E-1

The beverage E prepared in Production Example 5 was filled in an aluminum can. In Examples E-1 to E-3, magnesium hydride (MgH₂) as a hydrogen generating material was added at a concentration shown in Table 5, and, in Comparative Example E-1, the can was filled with carbon dioxide gas so that the gas pressure of the packaged beverage was 2.2 kg/cm², and sealed, without any operation, thereby producing four packaged beverage samples each.

The amount of dissolved oxygen in the beverages of Examples E-1 to E-3 and the beverage of Comparative Example E-1 was 0.5 mg/L or less.

Among the four packaged beverage samples, the temperature of one sample was adjusted to 20° C., the oxidation-reduction potential of the beverage immediately after production was measured based on the measurement method described above, the temperature of another sample was adjusted to around 4° C., and the sensory evaluation described above was performed. In addition, the remaining two samples were left to stand for one week in an environment of 37° C. to deteriorate, then the temperature of one sample was adjusted to 20° C., the oxidation-reduction potential of the beverage after standing was measured based on the measurement method described above, and the temperature of another sample was adjusted to around 4° C., and the sensory evaluation described above. The results are shown in Table 5.

TABLE 5

| | Comparative | | | |
|---|---|---|---|---|
| | Example E-1 | Example E-1 | Example E-2 | Example E-3 |
| Method for adjusting oxidation- | None | Addition of | Addition of | Addition of |
| reduction potential | | MgH₂ | MgH₂ | MgH₂ |
| Amount (g/L) of hydrogen | — | 0.4 | 0.8 | 1.2 |
| generating material added | | | | |
| Oxidation-reduction potential | 127 | −17.5 | −98.5 | −288.5 |
| (mV) of beverage immediately | | | | |
| after production | | | | |
| Oxidation-reduction potential | 284.5 | 10.5 | −63.5 | −260.5 |
| (mV) of beverage after standing | | | | |
| Flavor evaluation of beverage | 5.0 (reference) | 4.5 | 4.4 | 4.2 |
| immediately after production | | | | |
| Flavor evaluation of beverage | 3.0 | 3.1 | 3.4 | 3.9 |
| after standing | | | | |

From Table 5, it was confirmed that the beverages of Examples E-1 to E-3 had excellent results in the flavor evaluation of the beverage after standing at 37° C. for one week as compared with the beverage of Comparative Example E-1, and had the effect of suppressing a decrease in deterioration.

### Examples F-1 to F-3 and Comparative Example F-1

The beverage F prepared in Production Example 6 was filled in an aluminum can. In Examples F-1 to F-3, magnesium hydride (MgH₂) as a hydrogen generating material was added at a concentration shown in Table 6, and, in Comparative Example F-1, the can was filled with carbon dioxide gas so that the gas pressure of the packaged beverage was 2.2 kg/cm², and sealed, without any operation, thereby producing four packaged beverage samples each.

The amount of dissolved oxygen in the beverages of Examples F-1 to F-3 and the beverage of Comparative Example F-1 was 0.5 mg/L or less.

Among the four packaged beverage samples, the temperature of one sample was adjusted to 20° C., the oxidation-reduction potential of the beverage immediately after production was measured based on the measurement method described above, the temperature of another sample was adjusted to around 4° C., and the sensory evaluation described above was performed. In addition, the remaining two samples were left to stand for one week in an environment of 37° C. to deteriorate, then the temperature of one sample was adjusted to 20° C., the oxidation-reduction potential of the beverage after standing was measured based on the measurement method described above, and the temperature of another sample was adjusted to around 4° C., and the sensory evaluation described above. The results are shown in Table 6.

TABLE 6

| | Comparative | | | |
|---|---|---|---|---|
| | Example F-1 | Example F-1 | Example F-2 | Example F-3 |
| Method for adjusting oxidation- | None | Addition of | Addition of | Addition of |
| reduction potential | | MgH₂ | MgH₂ | MgH₂ |
| Amount (g/L) of hydrogen | — | 0.4 | 0.8 | 1.2 |
| generating material added | | | | |
| Oxidation-reduction potential | 105 | −34.5 | −120.5 | −310.5 |
| (mV) of beverage immediately | | | | |
| after production | | | | |
| Oxidation-reduction potential | 262.5 | −6.5 | −85.5 | −282.5 |
| (mV) of beverage after standing | | | | |
| Flavor evaluation of beverage | 5.0 (reference) | 4.6 | 4.4 | 4.2 |
| immediately after production | | | | |
| Flavor evaluation of beverage | 3.0 | 3.2 | 3.5 | 4.0 |
| after standing | | | | |

From Table 6, it was confirmed that the beverages of Examples F-1 to F-3 had excellent results in the flavor evaluation of the beverage after standing at 37° C. for one week as compared with the beverage of Comparative Example F-1, and had the effect of suppressing a decrease in deterioration.

1. A packaged beverage in which a beverage is filled in a container,
the packaged beverage having an oxidation-reduction potential adjusted to 5.00 mV or less with a hydrogen generating material.

2. The packaged beverage according to claim 1, wherein the packaged beverage has a real extract concentration of 0.1 mass % or more.

3. The packaged beverage according to claim 1, wherein the beverage is drinking water, a carbonated beverage, a fruit beverage, a vegetable beverage, a fruit juice beverage, a vegetable juice beverage, a fruit juice-flavored beverage, a vegetable juice-flavored beverage, a fruit pulp beverage, a flavored beverage, a flavored syrup, an acidic beverage produced from milk or a dairy product, a coffee beverage, a caffeine beverage, a tea-based beverage, a soymilk beverage, or an alcoholic beverage.

4. The packaged beverage according to claim 1, wherein the beverage is a beer-taste beverage.

5. The packaged beverage according to claim 1, wherein the container is a bottle, a can, a bottle can, a barrel, a PET bottle, a plastic bottle, or a stainless steel container.

6. The packaged beverage according to claim 1, wherein the packaged beverage has a gas pressure of 0.01 kg/cm² or more.

7. The packaged beverage according to claim 1, wherein an additive containing the hydrogen generating material is incorporated into the beverage or the container.

8. The packaged beverage according to claim 1, wherein the container is a beverage filling container (I) having a layer containing the hydrogen generating material and/or a beverage filling container (II) in which a member containing the hydrogen generating material is present.

9. The packaged beverage according to claim 1, wherein the hydrogen generating material contains one or more selected from a metal, a metal alloy, and a metal compound.

10. The packaged beverage according to claim 1, wherein the hydrogen generating material contains one or more selected from magnesium hydride, calcium hydride, barium hydride, beryllium hydride, strontium hydride, lithium hydride, sodium hydride, sodium borohydride, lithium sodium hydride, silicon hydride, magnesium, and a magnesium alloy.

11. The packaged beverage according to claim 1, wherein a content of an antioxidant is 1.0 mass % or less.

12. The packaged beverage according to claim 1, wherein an amount of dissolved oxygen is 14 mg/L or less.

13. A packaged grain beverage having an oxidation-reduction potential of 5.00 mV or less.

14. A packaged beer-taste beverage having an oxidation-reduction potential of 5.00 mV or less.

15. A method for producing a packaged beverage, the method comprising a step (A) of adjusting an oxidation-reduction potential of a beverage to 5.00 mV or less with a hydrogen generating material.

16. The method for producing a packaged beverage according to claim 15, wherein, in the step (A), the oxidation-reduction potential of the beverage is adjusted to 5.00 mV or less with the hydrogen generating material after the beverage is filled in a container.

17. The method for producing a packaged beverage according to claim 15, wherein the step (A) is carried out by incorporating an additive containing the hydrogen generating material into the beverage or the container.

18. The method for producing a packaged beverage according to claim 15, wherein the step (A) is carried out by filling the beverage in a beverage filling container (I) having a layer containing the hydrogen generating material or in a beverage filling container (II) in which a member containing the hydrogen generating material is present.

19. The method for producing a packaged beverage according to claim 15, wherein the hydrogen generating material contains one or more selected from a metal, a metal alloy, and a metal compound.

20. The method for producing a packaged beverage according to claim 15, wherein the hydrogen generating material contains one or more selected from magnesium hydride, calcium hydride, barium hydride, beryllium hydride, strontium hydride, lithium hydride, sodium hydride, sodium borohydride, lithium sodium hydride, silicon hydride, magnesium, and a magnesium alloy.

21. A method for suppressing deterioration of a packaged beverage, the method comprising adjusting an oxidation-reduction potential of a beverage to 5.00 mV or less with a hydrogen generating material.

22. A beverage filling container comprising a layer containing a hydrogen generating material and/or a member containing a hydrogen generating material.
